(19) United States
(12) Patent Application Publication
(10) Pub. No.: US 2022/0410543 A1
(43) Pub. Date: Dec. 29, 2022

(54) MULTILAYER WATER-DISPERSIBLE ARTICLES

(71) Applicant: MONOSOL, LLC, Merrillville, IN (US)

(72) Inventors: JONATHON KNIGHT, MERRILLVILLE, IN (US); RICHARD GOETZ, MERRILLVILLE, IN (US); JASON ROMAINE, MERRILLVILLE, IN (US); AKIO NISHIMI, MERRILLVILLE, IN (US)

(73) Assignee: MONOSOL, LLC, Merrillville, IN (US)

(21) Appl. No.: 17/771,359

(22) PCT Filed: Oct. 26, 2020
(86) PCT No.: PCT/US2020/057288

§ 371 Date: Apr. 22, 2022

Related U.S. Application Data
(60) Provisional application No. 62/926,293, filed on Oct. 25, 2019.

(51) Int. Cl. B32B 27/08; B32B 27/30; B32B 27/32

(52) U.S. Cl. CPC B32B 27/08; B32B 27/306; B32B 27/32; B32B 2307/7166; B32B 2307/718; B32B 2391/00

(57) ABSTRACT

Disclosed herein are multilayer water-dispersible articles, optionally a film, comprising a water-soluble polymer and a wax. Also disclosed are multilayer water-dispersible articles including a water-dispersible substrate layer having a thickness in a range of about 5 μm to about 10 mm, and a water-dispersible coating layer on the substrate layer, the coating layer having a thickness in a range of about 0.5 to about 250 μm, wherein water-dispersible article has a moisture vapor transmission rate (MVTR) of about 60 g H₂O/m²/day to about 300 g H₂O/m²/day or less.

### CROSS-REFERENCE TO RELATED APPLICATIONS

This application claims the benefit under 35 U.S.C. § 119(e) of U.S. Provisional Patent Application Ser. No. 62/926,293, filed Oct. 25, 2019, the entire disclosure of which is incorporated herein by reference.

### FIELD OF THE DISCLOSURE

The present disclosure relates generally to water-dispersible articles, such as multilayer water-dispersible articles. In particular, the disclosure relates to water-dispersible articles including a water-soluble polymer and a wax. More particularly, the disclosure relates to multilayer water-dispersible articles having a water-dispersible substrate layer or material comprising a water-soluble polymer and a water-dispersible coating layer or material disposed or arranged on a surface of the substrate layer or material. The disclosure relates to a water-dispersible article, wherein the article has a moisture vapor transmission rate (MVTR) of about 20 g H₂O/m²/day or less, such as 10 g H₂O/m²/day or less.

### BACKGROUND

Water-soluble and water-dispersible articles are commonly used as packaging to simplify dispersing, pouring, dissolving and dosing of a composition to be delivered. A consumer can directly add the packaged composition to a mixing vessel, such as a bucket, sink or any vessel suitable for holding water. Advantageously, this provides for accurate dosing while eliminating the need for the consumer to measure the composition. The packaged composition may also reduce mess that would be associated with dispensing a composition from a product container, such as pouring or scooping a material. In sum, soluble and dispersible pre-measured packages or articles provide for convenience of consumer use in a variety of applications.

Water-dispersible articles that are used to make currently marketed packages would be useful for containing harsh chemicals or materials otherwise affected by the presence of water, for example, hygroscopic compositions or water-activated compositions. Notably, a unit dose package or pouch that can contain materials such as yeast, an ingredient that activates in the presence of water, would be particularly advantageous in industrial-scale baking, insomuch as the yeast would be separated from moisture until it is intentionally activated. Furthermore, a unit dose pouch, that can hold harsh chemicals would be particularly advantageous to protect the consumer from directly contacting such chemicals. However, at present, the water-soluble polymers used in these applications can incompletely dissolve after prolonged exposure to a harsh chemical contained therein, or can allow the permeation of moisture from the environment to the components contained therein. Such problems may particularly arise when the pouch is used, for example, to contain harsh oxidizing compounds, such as chlorinated compounds, or food ingredients, such as yeast, sugar, or salt.

Thus there is a need for a water-dispersible articles that can hold harsh chemicals and/or other materials that can be affected by the presence of moisture, but that remain water-dispersible after being in contact with said chemical and/or materials.

### SUMMARY

One aspect of the disclosure provides a multilayer water-dispersible article, optionally a film, comprising a water-soluble polymer and a wax, wherein the wax is present in an amount ranging from about 5 PHR to about 30 PHR, based on 100 parts by weight of the water-soluble polymer, and the water-dispersible article has a moisture vapor transmission rate (MVTR) of about 20 g H₂O/m²/day or less.

Another aspect of the disclosure provides a method of making a multilayer water-dispersible article comprising admixing a water-soluble polymer and a wax emulsion to provide a primary composition, and casting or extruding the primary composition to provide the multilayer water-dispersible article, wherein the water-dispersible article has a moisture vapor transmission rate (MVTR) of about 20 g H₂O/m²/day or less.

Another aspect of the disclosure provides a multilayer water-dispersible article including a water-dispersible substrate layer having a thickness in a range of about 5 to about 400 μm, and a water-dispersible coating layer on the substrate layer, the coating layer having a thickness in a range of about 0.5 to about 100 μm, wherein the multilayer water-dispersible article has a moisture vapor transmission rate (MVTR) of about 20 g H₂O/m²/day or less, such as 10 g H₂O/m²/day or less.

Another aspect of the disclosure provides a multilayer water-dispersible article including a water-dispersible substrate layer having a thickness in a range of about 0.5 to about 10 mm, and a water-dispersible coating layer on the substrate layer, the coating layer having a thickness in a range of about 0.5 to about 250 μm, wherein the multilayer water-dispersible article has a moisture vapor transmission rate (MVTR) of 20 g H₂O/m²/day or less, such as 10 g H₂O/m²/day or less.

Another aspect of the disclosure provides a method of making a water-dispersible article including providing a water-dispersible substrate layer having a thickness in a range of about 0.5 to about 10 mm, providing a water-dispersible coating including a water-dispersible paraffin wax, oxidized polyethylene, microcrystalline wax, mineral oil, natural petroleum wax, synthetic petroleum wax, wood rosin, carnauba wax, candelilla wax, beeswax, shellac, a triglyceride, linseed oil, corn oil, canola oil, hemp oil, coconut oil, a derivative of any of the foregoing, or a mixture of any of the foregoing at a temperature in a range of about 20° C. to 200° C., contacting a surface of the substrate layer with the coating to provide a substrate layer having a coating layer thereon, wherein the coating layer has a thickness in a range of about 0.5 to about 250 μm, optionally cooling and/or drying the coating layer, thereby providing a multilayer water-dispersible article, wherein the water-dispersible substrate layer and the water-dispersible coating layer are selected to provide the multilayer water-dispersible article with a moisture vapor transmission rate (MVTR) of 20 g H₂O/m²/day or less, such as 10 g H₂O/m²/day or less.

Another aspect of the disclosure provides a method of making a water-dispersible article, including providing a water-dispersible substrate layer having a thickness in a range of about 0.5 to about 10 mm, providing a water-dispersible coating layer including a water-dispersible polyvinyl alcohol, polyacrylamide, poly(acrylic acid), poly(methacrylic acid), polyvinylpyrrolidone, a quaternary ammonium polymer, polyvinyl acetate, ethylene vinyl alcohol, alginate, a polysaccharide, a derivative of any of the foregoing, or a mixture of any of the foregoing to provide a coating layer having a thickness in a range of about 0.5 to about 250 μm; contacting the coating layer to the substrate layer to provide a multilayer water-dispersible article, wherein the water-dispersible substrate layer and the water-dispersible coating layer are selected to provide the multilayer water-dispersible article with a moisture vapor transmission rate (MVTR) of 20 g H₂O/m²/day or less, such as 10 g H₂O/m²/day or less.

For the compositions, articles, and methods described herein, optional features, including but not limited to components and compositional ranges thereof, are contemplated to be selected from the various aspects, embodiments, and examples provided herein.

Further aspects and advantages will be apparent to those of ordinary skill in the art from a review of the following detailed description. While the article(s), pouch, and their methods of making are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

For further facilitating the understanding of the present disclosure, one drawing figure is attached hereto.

FIG. 1 shows a cross-sectional area of an article of the disclosure including a polymer layer 10 comprising a water-soluble polymer, a wax layer 20 comprising a wax, and an intermediate region 30 comprising a mixture of the water-soluble polymer and the wax.

### DETAILED DESCRIPTION

In embodiments, the disclosure provides multilayer water-dispersible articles comprising a water-soluble polymer and a wax. In embodiments, the disclosure provides multilayer water-dispersible articles including a polymer layer (including, for example, a water-soluble polymer) and a wax layer (including, for example, a wax). As described herein, the article is a multilayer water-dispersible article. The term “multilayer water-dispersible article,” as used herein, can refer to an article prepared by a process that includes coating a distinct, self-supporting, substrate layer with a coating layer to provide a multilayer article. Despite this process, it should be understood by the person of ordinary skill that an article prepared in this way may still not have discrete or otherwise distinct layers—that is, the coating layer can be entangled, fused, intertwined, blended, or otherwise associated with a surface of the substrate layer, providing an interactive barrier on the substrate layer that can contribute, along with the substrate layer itself, to the moisture vapor transmission rate of the article. Alternatively, or additionally, the term “multilayer water-dispersible article” can refer to an article prepared by a process that includes admixing the components (e.g., the components making up the substrate and/or coating layer) together in a single composition, followed by casting, extruding, or otherwise forming (e.g. molding) the article from the single composition. The articles formed by this process can undergo a “blooming effect” in which some components migrate through the article to a surface of the article to provide a multilayered, “quasi-coating” on a surface of the article. Advantageously, the articles of the disclosure, for example a water-dispersible film, can demonstrate substantially maintained or improved functional properties, relative to a water-dispersible film not including a wax or coating material, including but not limited to formability and sealing properties (e.g., forming and sealing a pouch), as well as tensile properties. Further advantageously, the MVTR of the article can be maintained over time (e.g., storage life), yet readily disperse upon use.

Examples of suitable articles can include, but are not limited to, films, containers and objects made from films (e.g., unit-dose pouches, packages), and injection moldable objects, such as bottles, clamshells, boxes, and the like

### Multilayer Water-Dispersible Articles Including a Substrate Layer & a Coating Layer

One aspect of the disclosure provides a multilayer water-dispersible article, such as a film, pouch, or a bottle, including a water-dispersible substrate layer having a thickness in a range of about 5 to about 400 μm, and a water-dispersible coating layer on the substrate layer, the coating layer having a thickness in a range of about 0.5 to about 100 μm, wherein the water-dispersible article has a moisture vapor transmission rate (MVTR) of about 20 g H₂O/m²/day or less, such as 10 g H₂O/m²/day or less.

The substrate layer and coating layer are not particularly limited, provided that they are each water-dispersible or water-soluble and the multilayer article formed therefrom is water-dispersible or water soluble. As used herein, “water-soluble” means that, according to the Dissolution and Disintegration Test MSTM 205 as described herein, after 300 s, there are no visible particles or undissolved fragments of the article and/or layer(s) in the beaker solution. That is, a water-soluble article has a percent residue, as described herein, of about 0% remaining in the slide mount after 300 s. As used herein, “water-dispersible” means that, according to the Dissolution and Disintegration Test MSTM 205 as described herein, after 300 s, there may be some visible particles or undissolved fragments of the article and/or layer(s) in the beaker solution. That is, a water-dispersible article has a percent residue, as described herein, of about 25% or less remaining in the slide mount after 300 s.

### Substrate Layer

In embodiments, the substrate layer includes water-dispersible polyvinyl alcohol, polyacrylamide, poly(acrylic acid), poly(methacrylic acid), polyvinylpyrrolidone, quaternary ammonium polymers, alginate, a polysaccharide, a protein, a pH-adjusted protein, wood pulp, non-wood pulp, non-woven fiber, natural foam, synthetic foam, a derivative of any of the foregoing, or a mixture of any of the foregoing.

In embodiments, the substrate layer includes polyvinyl alcohol (PVOH). Polyvinyl alcohol is a synthetic resin generally prepared by the alcoholysis, usually termed hydrolysis or saponification, of polyvinyl acetate. Fully hydrolyzed PVOH, where virtually all the acetate groups have been converted to alcohol groups, is a strongly hydrogen-bonded, highly crystalline polymer which dissolves only in hot water, at temperatures greater than about 140° F. (about 60° C.). If a sufficient number of acetate groups are allowed to remain after the hydrolysis of polyvinyl acetate, that is, the PVOH polymer is partially hydrolyzed, then the polymer is more weakly hydrogen-bonded, less crystalline, and is generally soluble in cold water, at temperatures less than about 50° F. (about 10° C.). As such, the partially hydrolyzed polymer is a vinyl alcohol-vinyl acetate copolymer that is a PVOH copolymer, but is commonly referred to as homopolymer PVOH or an unmodified PVOH.

In embodiments, the substrate layer includes unmodified polyvinyl alcohol. In embodiments, the substrate layer includes an anionic group-modified PVOH. The anionic group-modified PVOH can be a copolymer of polyvinyl alcohol and an anionic group. The PVOH resin present in the substrate layer can include one or more PVOH polymers or can consist of or consist essentially of a single PVOH polymer.

When the substrate layer includes an anionic group-modified polyvinyl alcohol, the PVOH can be modified with an anionic group selected from vinyl acetic acid, maleic acid, monoalkyl maleate, dialkyl maleate, monomethyl maleate, dimethyl maleate, maleic anhydride, fumaric acid, monoalkyl fumarate, dialkyl fumarate, monomethyl fumarate, dimethyl fumarate, itaconic acid, monomethyl itaconate, dimethyl itaconate, itaconic anhydride, carboxylic acid, aminopropyl sulfonate, n-vinylpyrrolidone, n-vinyl-caprolactam, an alkali metal salt of any of the foregoing, an ester of any of the foregoing, a derivative of any of the foregoing, or a combination of any of the foregoing. Optionally, the polyvinyl alcohol can be modified with an anionic group selected from one or more of maleic acid, monoalkyl maleate, dialkyl maleate, monomethyl maleate, dimethyl maleate, maleic anhydride, an alkali metal salt of any of the foregoing, an ester of any of the foregoing, and a combination of any of the foregoing. Further optionally, the polyvinyl alcohol can be modified with an anionic group consisting of maleic acid, monomethyl maleate, dimethyl maleate, maleic anhydride, an alkali metal salt of any of the foregoing, an ester of any of the foregoing, and a combination of any of the foregoing.

When the substrate layer includes an anionic group modified PVOH, the level of modification is not particularly limited. In embodiments, the one or more anionic groups are present in the PVOH in an amount ranging from about 0.5 mol. % to about 10 mol. %, about 1 mol. % to about 9 mol. %, about 1.5 mol. % to about 8 mol. %, about 2 mol. % to about 6 mol. %, about 3 mol. % to about 5 mol. %, or about 1 mol. % to about 4 mol. %, for example at least about 0.5, about 1.0, about 1.5, about 2.0, about 2.5, about 3.0, about 3.5, or about 4.0 mol. % and/or up to about 3.0, about 4.0, about 4.5, about 5.0, about 6.0, about 8.0, or about 10 mol. % in various embodiments. In embodiments, the anionic group modified polyvinyl alcohol includes at least about 0.5 mol. % modification. In embodiments, the anionic group modified polyvinyl alcohol includes about 1.0 mol. % to about 4.0 mol. % modification. In embodiments, the anionic group modified polyvinyl alcohol includes about 1.0 mol % to about 3.5 mol. % modification.

In embodiments, the amount of PVOH resin, when present in the substrate layer, can be in a range of at least about 50 wt. %, about 55 wt. %, about 60 wt. %, about 65 wt. %, about 70 wt. %, about 75 wt. %, about 80 wt. %, about 85 wt. %, or about 90 wt. % and/or up to about 60 wt. %, about 70 wt. %, about 80 wt. %, about 90 wt. %, about 95 wt. %, or about 99 wt. %, based on the weight of the substrate layer.

In embodiments, the total PVOH resin content of the substrate layer, when present as either an unmodified PVOH or an anionic group-modified PVOH, can have a degree of hydrolysis (D.H. or DH) of at least about 80 mol. %, about 84 mol. %, about 85 mol. %, about 88 mol. %, or about 90 mol. % and at most about 99.7 mol. %, about 99 mol. %, about 98 mol. %, about 96 mol. %, or about 80 mol. %, for example in a range of about 80 mol. % to about 99.7 mol. %, about 84 mol. % to about 90 mol %, about 85 mol % to about 88 mol. %, about 86.5 mol. % to about 88 mol %, about 88 mol % to about 90 mol. %, about 94 mol. % to about 98 mol. %, about 85 mol. % to about 99.7 mol. %, about 87 mol. % to about 98 mol. %, about 89 mol. % to about 97 mol. %, or about 90 mol. % to about 96 mol. %, for example about 88 mol. %, about 90 mol. %, about 92 mol. %, about 94 mol. %, or about 96 mol. %. As used herein, the degree of hydrolysis is expressed as a mole percentage of vinyl acetate units converted to vinyl alcohol units. In embodiments, the PVOH has a degree of hydrolysis of at least 88 mol. %. In embodiments, the PVOH has a degree of hydrolysis of at least 90 mol. %. In embodiments, the PVOH has a degree of hydrolysis of less than 99 mol. %.

The viscosity of a PVOH polymer (p) is determined by measuring a freshly made solution using a Brookfield LV type viscometer with UL adapter as described in BS EN ISO 15023-2:2006 Annex E Brookfield Test method. It is international practice to state the viscosity of 4% aqueous polyvinyl alcohol solutions at 20° C. All viscosities specified herein in Centipoise (cP) should be understood to refer to the viscosity of 4% aqueous polyvinyl alcohol solution at 20° C., unless specified otherwise. Similarly, when a polymer is described as having (or not having) a particular viscosity, unless specified otherwise, it is intended that the specified viscosity is the average viscosity for the polymer, which inherently has a corresponding molecular weight distribution. Additionally, when a resin includes a blend of one or more PVOH polymers and the resin/blend is described as having (or not having) a particular viscosity, unless specified otherwise, it is intended that the specified viscosity is the weighted average viscosity for the resin/blend, which inherently has a corresponding weighted average molecular weight distribution.

In embodiments wherein the substrate layer includes PVOH, the PVOH can have a viscosity average of at least about 5 cP, about 6 cP, about 8 cP, about 10 cP about 12 cP, about 13 cP, about 13.5 cP, about 14 cP, about 15 cP, about 16 cP, about 17 cP, about 18 cP, about 19 cP, or about 20 cP and at most about 30 cP, about 28 cP, about 27 cP, about 26 cP, about 24 cP, about 22 cP, about 20 cP, about 19 cP, about 18 cP, or about 17.5 cP, for example in a range of about 10 cP to about 30 cP, or about 13 cP to about 27 cP, or about 13.5 cP to about 20 cP, or about 18 cP to about 22 cP, or about 14 cP to about 19 cP, or about 16 cP to about 18 cP, or about 17 cP to about 16 cP, for example 23 cP, or 20 cP, or 16.5 cP. It is well known in the art that the viscosity of PVOH is correlated with the weight average molecular weight (M̅w) of the PVOH, and often the viscosity is used as a proxy for the M̅w.

Other water-dispersible polymers that can be used in the substrate layer can include, but are not limited to a vinyl alcohol-vinyl acetate copolymer, sometimes referred to as a PVOH homopolymer (or unmodified PVOH), polyvinyl acetates, ethylene vinyl alcohols, polyacrylates, poly(meth)acrylates, water-dispersible acrylate copolymers, polyvinylpyrrolidone, polyethyleneimine, polyalkylene oxides, polyacrylamides, polyacrylic acids and salts thereof, polymethacrylic acids, polycarboxylic acids and salts thereof, polyaminoacids, polyamides, gelatines, quaternary ammonium polymers, polymethacrylates, and combinations of any of the foregoing. Such water-dispersible polymers, whether PVOH or otherwise are commercially available from a variety of sources.

The substrate layer can include water-dispersible natural polymers, such as polysaccharides, including, but not limited to, guar gum, gum Acacia, xanthan gum, carrageenan, starch, celluloses, cellulose ethers (such as carboxymethylcellulose), cellulose esters, cellulose amides, glycogen, chitin, water-dispersible polymer derivatives including, but not limited to, modified starches, ethoxylated starch, and hydroxypropylated starch, copolymers of the forgoing and combinations of any of the foregoing.

The substrate layer can include proteins. In embodiments, the substrate layer includes pH-adjusted proteins. Examples of suitable proteins include, but are not limited to, soy, whey, casein, caseinate, and pullalan. Each of these proteins may or may not be pH-adjusted and still be suitable for the substrate layer according to the disclosure.

The substrate layer can include water-dispersible paper(s) made in part from wood pulp and non-wood pulp. In embodiments, the substrate layer includes wood pulp. Suitable examples of sources of wood pulp include, but are not limited to, wood from needle-leaved trees, and broad-leaved trees. In embodiments, the substrate layer includes non-wood pulp. Suitable examples of sources of non-wood pulp include, but are not limited to, hemp, linter, kenaf, bagasse, and manila hemp.

In embodiments wherein the substrate layer includes wood pulp or non-wood pulp, the substrate layer can further include additional auxiliary agents, such as plasticizers, natural polymers, water-dispersible polymers, binders, surfactants, and/or alkali metal compounds.

Examples of compositions of water-dispersible papers are well-known in the art, and are taught in, for example, U.S. Pat. Nos. 9,388,532, 5,935,384, 7,758,724, U.S. Patent Application Publication No. 2005/0092451, European Patent No. 0 372 388 B1. European Patent Application Publication No. 0 609 808 A1, and U.S. Pat. No. 3,034,922, each of which is incorporated herein by reference in its entirety.

In embodiments, the substrate layer includes carboxymethylcellulose and a polyvinyl alcohol modified with monomethyl maleate. In some embodiments, the substrate layer includes unmodified polyvinyl alcohol.

The substrate layer can further include one or more plasticizers. A plasticizer is a liquid, solid, or semi-solid that is added to a material (usually a resin or elastomer) making that material softer, more flexible (by decreasing the glass-transition temperature and crystallinity of the polymer), and easier to process. A polymer can alternatively be internally plasticized by chemically modifying the polymer or monomer. In addition, or in the alternative, a polymer can be externally plasticized by the addition of a suitable plasticizing agent. Water is recognized as a very efficient plasticizer for PVOH and other polymers; including but not limited to water soluble polymers, however, the volatility of water makes its utility limited since polymer films need to have at least some resistance (robustness) to a variety of ambient conditions including low and high relative humidity.

Suitable non-water plasticizers include, but are not limited to, glycerol, diglycerol, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane (TMP), polyether polyols, 2-methyl-1,3-propanediol (e.g. MP Diol®), ethanolamines, isomalt, maltitol, xylitol, erythritol, adonitol, dulcitol, pentaerythritol, mannitol, and combinations of the foregoing.

When present, the total amount of the non-water plasticizer present in the substrate layer can be in a range of up to about 50 wt. %, based on the weight of the substrate layer, for example from about 5% to about 50%, about 10 wt. % to about 45 wt. %, about 20 wt. % to about 45 wt. %, about 15 wt. % to about 35 wt. %, or about 20 wt. % to about 30 wt. %, for example about 25 wt. %, based on weight of the substrate layer. The total amount of plasticizer can also be expressed in parts per 100 parts resin, for example, parts per 100 parts polyvinyl alcohol resin. Thus, the total amount of plasticizer can be in a range of about 2 PHR to about 30 PHR, about 5 PHR to about 25 PHR, about 2 PHR to about 11 PHR, about 5 PHR to about 10 PHR, about 15 PHR to about 20 PHR, about 16 PHR to about 18 PHR, about 21 PHR to about 27 PHR, about 23 PHR to about 25 PHR, or less than about 25 PHR, less than about 20 PHR, less about 17.5 PHR, less than about 12 PHR, less than about 10 PHR, less than about 8 PHR, less than about 7.5 PHR, or at least 2 PHR, at least 5 PHR, at least 6.5 PHR, at least 10 PHR, or at least 15 PHR.

Plasticizer levels consistent with those of the examples described herein are specifically contemplated both as representative levels for substrate layer formulations with various of the other ingredients described herein, and as various upper and lower bounds for ranges. The specific amounts of plasticizers can be selected in a particular embodiment based on factors described herein, including desired substrate layer flexibility and conversion features of the substrate layer. At low plasticizer levels, substrate layers may become brittle, difficult to process, or prone to breaking. At elevated plasticizer levels, substrate layers may be too soft, weak, or difficult to process for a desired use.

The substrate layer can contain other auxiliary agents and processing agents, such as, but not limited to, surfactants, dispersants, lubricants, release agents, slip agents, fillers, extenders, cross-linking agents, antiblocking agents, antioxidants, detackifying agents, antifoams (defoamers), nanoparticles such as layered silicate-type nanoclays (e.g., sodium montmorillonite), bleaching agents (e.g., sodium metabisulfite, sodium bisulfite or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes. In embodiments, the substrate layer may include a filler, a surfactant, an anti-block agent, an antioxidant, a slip agent, a dispersant, or combinations of the foregoing.

Surfactants for use in water soluble films can be used in the substrate layer, and such surfactants are well known in the art. Optionally, surfactants are included to aid in the dispersion of a resin solution upon casting or extruding. Suitable surfactants for substrate layers of the present disclosure include, but are not limited to, dialkyl sulfosuccinates, lactylated fatty acid esters of glycerol and propylene glycol, lactylic esters of fatty acids, sodium alkyl sulfates, polysorbate 20, polysorbate 60, polysorbate 65, polysorbate 80, alkyl polyethylene glycol ethers, lecithin, acetylated fatty acid esters of glycerol and propylene glycol, sodium lauryl sulfate, acetylated esters of fatty acids, myristyl dimethylamine oxide, trimethyl tallow alkyl ammonium chloride, quaternary ammonium compounds, salts thereof and combinations of any of the forgoing. Too little surfactant can sometimes result in a substrate layer having holes, whereas too much surfactant can result in the substrate layer having a greasy or oily feel from excess surfactant present on the surface of the substrate layer. Thus, surfactants can be included in the substrate layer in an amount of less than about 2 PHR, for example less than about 1 PHR, or less than about 0.5 PHR, for example.

One type of secondary component contemplated for use is a defoamer. Defoamers can aid in coalescing of foam bubbles. Suitable defoamers for use in substrate layers according to the present disclosure include, but are not limited to, hydrophobic silicas, for example silicon dioxide, siloxane, silicone ethers, or fumed silica in fine particle sizes, and proprietary, non-mineral oil defoamers including Foam Blast® defoamers available from Emerald Performance Materials, including Foam Blast® 327, Foam Blast® UVD. Foam Blast® 163, Foam Blast® 269, Foam Blast®338, Foam Blast® 290, Foam Blast® 332, Foam Blast® 349, Foam Blast® 550 and Foam Blast® 339. In embodiments, defoamers can be used in an amount of 0.5 PHR, or less, for example, 0.05 PHR, 0.04 PHR, 0.03 PHR, 0.02 PHR, or 0.01 PHR.

Suitable fillers/extenders/antiblocking agents/detackifying agents include, but are not limited to, starches, modified starches, crosslinked polyvinylpyrrolidone, crosslinked cellulose, microcrystalline cellulose, silica, metallic oxides, calcium carbonate, talc, mica, stearic acid and metal salts thereof, for example, magnesium stearate. Preferred materials are starches, modified starches and silica. In one type of embodiment, the amount of filler/extender/antiblocking agent/detackifying agent in substrate layer can be in a range of about 1 wt % to about 6 wt %, or about 1 wt. % to about 4 wt. %, or about 2 wt. % to about 4 wt. %, or about 1 PHR to about 6 PHR, or about 1 PHR to about 4 PHR, or about 2 PHR to about 4 PHR, for example.

An anti-block agent, for example, SiO₂ and/or stearic acid, can be present in the substrate layer in an amount of at least 0.1 PHR, or at least 0.5 PHR, or at least 1 PHR, or in a range of about 0.1 to 5.0 PHR, or about 0.1 to about 3.0 PHR, or about 0.4 to 1.0 PHR, or about 0.5 to about 0.9 PHR, or about 0.5 to about 2 PHR, or about 0.5 to about 1.5 PHR, or 0.1 to 1.2 PHR, or 0.1 to 2.7 PHR, for example 0.5 PHR, 0.6 PHR, 0.7 PHR, 0.8 PHR, or 0.9 PHR.

A suitable median particle size for the anti-block agent includes a median size in a range of about 3 or about 4 microns to about 11 microns, or about 4 to about 8 microns, or about 5 to about 6 microns, for example 5, 6, 7, 8, 9, 10, or 11 microns. A suitable SiO₂ is an untreated synthetic amorphous silica designed for use in aqueous systems.

In embodiments, the substrate layer can be edible. For example, the substrate layer can consist essentially of or consist solely of edible ingredients. Components for inclusion in such substrate layers can be those designated as “Generally Recognized as Safe” (GRAS) by the United States Food and Drug Administration, and/or components with assigned, allowable E-numbers in the European Union, and/or components that are not yet designated as GRAS or E-numbered but have gone through proper testing and have been demonstrated as safe for human consumption in the amounts proposed for use in the substrate layer. In embodiments, the substrate layer can be or include a foodstuff, e.g. a foodstuff for human consumption, or a foodstuff for animal consumption.

In embodiments, the substrate layer can be formed by casting or extruding. In such embodiments, the solution used to cast, extrude, or otherwise form the substrate layer can have a viscosity ranging from about 5,000 cP to about 30,000 cP, about 10,000 cP to about 25,000 cP, or about 15,000 cP to about 20,000 cP, for example, about 5,000 cP, about 6,000 cP, about 10,000 cP, about 12,000 cP, about 13.000 cP, about 13.500 cP, about 14,000 cP, about 15,000 cP, about 16,000 cP, about 17.000 cP, about 18,000 cP, about 19,000 cP, about 20,000 cP, about 23,000 cP, about 25,000 cP, about 27,000 cP, or about 30,000 cP.

The thickness of the substrate layer is not particularly limited. Furthermore, depending on the method of making the multilayer water-dispersible article, as provided herein, in embodiments, the substrate layer and the coating layer are not each discrete layers in the multilayer article, such that the individual thicknesses of the coating layer and the substrate layer can be readily discerned. However, in embodiments, wherein a coating layer is applied to a surface of the substrate layer, it may be possible to determine a thickness for the substrate layer. In these embodiments, for example, the substrate layer can have a thickness ranging from about 5 μm to about 25,000 μm (25 mm), from about 10 μm to about 20,000 μm (20 mm), from about 100 μm to about 15,000 μm (15 mm), from about 250 μm to about 10,000 μm (10 mm), from about 500 μm to about 5,000 μm (5 mm), or from about 750 μm to about 1,000 μm (1 mm), for example about 5, about 10, about 15, about 25, about 50, about 75, about 100, about 150, about 200, about 250, about 300, about 350, about 400, about 450, about 500, about 550, about 600, about 650, about 700, about 750, about 800, about 850, about 900, about 950, about 1000, about 2000, about 3000, about 4000, about 5000, about 6000, about 7000, about 8000, about 9000, about 10,000, about 15,000, about 20,000, or about 25,000 μm.

In some embodiments, the substrate layer has a thickness ranging from about 5 μm to about 400 μm, about 10 μm to about 350 μm, about 15 μm to about 340 μm, about 50 μm to about 300 μm, about 75 μm to about 275 μm, about 90 μm to about 250 μm, about 100 μm to about 225 μm, about 115 μm to about 200 μm, about 125 μm to about 175 μm, or about 140 μm to about 152 μm, for example about 5, about 10, about 12, about 15, about 20, about 40, about 45, about 50, about 55, about 60, about 65, about 70, about 75, about 80, about 85, about 90, about 95, about 100, about 105, about 110, about 115, about 120, about 125, about 130, about 135, about 140, about 145, about 150, about 152, about 160, about 165, about 170, about 175, about 180, about 185, about 190, about 195, about 200, about 205, about 210, about 215, about 220, about 225, about 230, about 235, about 240, about 245, about 250, about 255, about 260, about 265, about 270, about 275, about 280, about 285, about 290, about 295, about 300, about 305, about 310, about 315, about 320, about 325, about 330, about 335, about 340, about 345, about 350, about 355, about 356, about 375, or about 400 μm.

For example, in embodiments, the substrate layer includes a water-dispersible paper having a thickness in a range of about 5 to about 356 μm. In some embodiments, the substrate layer includes a water soluble or water dispersible film having a thickness in a range of about 12 to about 152 μm.

In embodiments wherein the article is a film, the substrate layer can have a thickness ranging from, for example, about 5 μm to about 152 μm, about 10 μm to about 150 μm, about 15 μm to about 140 μm, about 50 μm to about 125 μm, about 75 μm to about 115 μm, or about 90 μm to about 100 μm, for example about 5, about 10, about 15, about 20, about 40, about 45, about 50, about 55, about 60, about 65, about 70, about 75, about 80, about 85, about 90, about 95, about 100, about 110, about 115, about 120, about 125, about 130, about 135, about 140, about 145, about 150, or about 152 μm.

In embodiments wherein the article is an injection moldable object or the like, such as, for example, a container having an open interior volume such as a bottle, a box, a clamshell, and the like, the substrate layer can have a thickness ranging from about 500 μm (0.5 mm) to about 10,000 μm (10 mm), about 700 μm (0.7 mm) to about 9,000 μm (9 mm), about 1,000 μm (1 mm) to about 7,500 μm (7.5 mm), from about 2,000 μm (2 mm) to about 6,000 μm (6 mm), or about 3,000 μm (3 mm) to about 5,000 μm (5 mm), for example about 500, about 600, about 700, about 750, about 800, about 850, about 900, about 1000, about 1250, about 1500, about 1750, about 2000, about 2500, about 3000, about 3500, about 4000, about 4500, about 5000, about 5500, about 6000, about 6500, about 7000, about 7500, about 8000, about 8500, about 9000, about 9500, or about 10,000 μm.

### Coating Layer

The water-dispersible article according to the disclosure includes a coating layer. The coating layer has a different composition from the substrate layer, and can serve as an additional barrier for the article. In general, the coating layer can improve the resistance of the substrate layer and/or article to moisture without detrimentally affecting the water-dispersibility of the article. That is, the coating layer can behave as a barrier to further protect the contents of the water-dispersible article from moisture or water vapor in the air, for example, when stored in a humid environment, prior to use.

The composition of the coating layer is not particularly limited. In embodiments, the coating layer includes a water-dispersible paraffin wax, oxidized polyethylene, microcrystalline wax, mineral oil, natural petroleum wax, synthetic petroleum wax, wood rosin, carnuba wax, candelilla wax, beeswax, shellac, a triglyceride, linseed oil, corn oil, canola oil, hemp oil, coconut oil, unmodified polyvinyl alcohol, anionic group modified polyvinyl alcohol, polyacrylamide, poly(acrylic acid), poly(methacrylic acid), polyvinylpyrrolidone, quaternary ammonium polymers, polyvinyl acetate, ethylene vinyl alcohol, alginate, a polysaccharide, a derivative of any of the foregoing, or a mixture of any of the foregoing.

In embodiments, the coating layer includes a blend of two or more different waxes. For example, the coating layer can include a blend of two or more waxes including, but not limited to, paraffin wax, microcrystalline wax, natural petroleum wax, synthetic petroleum wax, carnauba wax, candelilla wax, and/or beeswax.

When a blend of two waxes is included in the coating layer, the first wax can make up about 5 wt % to about 95 wt %, about 10 wt % to about 90 wt %, about 30 wt % to about 70 wt %, or 40 wt % to about 60 wt % of the wax blend, for example, the first wax can make up about 5, about 10, about 15, about 20, about 25, about 30, about 40, about 45, about 50, about 55, about 60, about 65, about 70, about 75, about 80, about 85, about 90, or about 95 wt % of the wax blend. Similarly, the second wax can make up about 5 wt % to about 95 wt %, about 10 wt % to about 90 wt %, about 30 wt % to about 70 wt %, or 40 wt % to about 60 wt % of the wax blend, for example, the second wax can make up about 5, about 10, about 15, about 20, about 25, about 30, about 40, about 45, about 50, about 55, about 60, about 65, about 70, about 75, about 80, about 85, about 90, or about 95 wt % of the wax blend. In embodiments wherein the coating layer consists of or consists essentially of a wax blend, the aforementioned amounts of first wax and second wax are based on the total weight of the coating layer.

The coating layer can include a blend of more than two waxes, for example, three, four, five, or six different waxes. Each wax can be present in any amount suitable to provide a coating layer in accordance with the disclosure.

In some embodiments, the coating layer can consist of or consist essentially of paraffin wax. In embodiments, the coating layer can consist of or consist essentially of beeswax. In embodiments, the coating layer includes from about 5 wt % to about 95 wt % paraffin wax and from about 5 wt % to about 95 wt % beeswax. For example, the ratio of beeswax to paraffin wax in the coating layer can be in a range of about 0:100 to about 100:0, from about 5.95 to about 95:5, from about 10:90 to about 90:10, from about 25:75 to about 75:25, from about 40:60 to about 60.40, or about 50:50.

The coating layer can contain other auxiliary agents and processing agents, such as, but not limited to, surfactants, dispersants, lubricants, release agents, slip agents, fillers, extenders, cross-linking agents, antiblocking agents, antioxidants, detackifying agents, antifoams (defoamers), nanoparticles such as layered silicate-type nanoclays (e.g., sodium montmorillonite), bleaching agents (e.g., sodium metabisulfite, sodium bisulfite or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes. In embodiments, the coating layer may include a filler, a surfactant, an anti-block agent, a bleaching agent, an antioxidant, a dispersant, a slip agent, or combinations any of the foregoing.

Surfactants for use in water soluble films can be used in the coating layer, and such surfactants are well known in the art. Optionally, surfactants are included to aid in the dispersion of a resin solution upon casting or extruding. Suitable surfactants for coating layers of the present disclosure include, but are not limited to, dialkyl sulfosuccinates, lactylated fatty acid esters of glycerol and propylene glycol, lactylic esters of fatty acids, sodium alkyl sulfates, polysorbate 20, polysorbate 60, polysorbate 65, polysorbate 80, alkyl polyethylene glycol ethers, lecithin, acetylated fatty acid esters of glycerol and propylene glycol, sodium lauryl sulfate, acetylated esters of fatty acids, myristyl dimethylamine oxide, trimethyl tallow alkyl ammonium chloride, quaternary ammonium compounds, salts thereof and combinations of any of the forgoing. Too little surfactant can sometimes result in a coating layer having holes, whereas too much surfactant can result in the coating layer having a greasy or oily feel from excess surfactant present on the surface of the substrate layer. Thus, surfactants can be included in the coating layer in an amount of less than about 2 PHR, for example less than about 1 PHR, or less than about 0.5 PHR, for example.

One type of secondary component contemplated for use is a defoamer. Defoamers can aid in coalescing of foam bubbles. Suitable defoamers for use in coating layers according to the present disclosure include, but are not limited to, hydrophobic silicas, for example silicon dioxide, siloxane, silicone ethers, or fumed silica in fine particle sizes, and proprietary, non-mineral oil defoamers including Foam Blast® defoamers available from Emerald Performance Materials, including Foam Blast® 327, Foam Blast® UVD, Foam Blast® 163, Foam Blast® 269, Foam Blast®338, Foam Blast® 290, Foam Blast® 332, Foam Blast® 349, Foam Blast® 550 and Foam Blast® 339. In embodiments, defoamers can be used in an amount of 0.5 PHR, or less, for example, 0.05 PHR, 0.04 PHR, 0.03 PHR, 0.02 PHR, or 0.01 PHR.

Suitable fillers/extenders/antiblocking agents/detackifying agents include, but are not limited to, starches, modified starches, crosslinked polyvinylpyrrolidone, crosslinked cellulose, microcrystalline cellulose, silica, diatomaceous earth, metallic oxides, calcium carbonate, talc, mica, stearic acid and metal salts thereof, for example, magnesium stearate. Preferred materials are starches, modified starches and silica. In one type of embodiment, the amount of filler/extender/antiblocking agent/detackifying agent in substrate layer can be in a range of about 1 wt % to about 6 wt %, or about 1 wt. % to about 4 wt. %, or about 2 wt. % to about 4 wt. %, or about 1 PHR to about 6 PHR, or about 1 PHR to about 4 PHR, or about 2 PHR to about 4 PHR, for example.

An anti-block agent, for example, SiO₂ and/or stearic acid, can be present in the coating layer in an amount of at least 0.1 PHR, or at least 0.5 PHR, or at least 1 PHR, or in a range of about 0.1 to 5.0 PHR, or about 0.1 to about 3.0 PHR, or about 0.4 to 1.0 PHR, or about 0.5 to about 0.9 PHR, or about 0.5 to about 2 PHR, or about 0.5 to about 1.5 PHR, or 0.1 to 1.2 PHR, or 0.1 to 2.7 PHR, for example 0.5 PHR, 0.6 PHR, 0.7 PHR, 0.8 PHR, or 0.9 PHR.

A suitable median particle size for the anti-block agent includes a median size in a range of about 3 or about 4 microns to about 11 microns, or about 4 to about 8 microns, or about 5 to about 6 microns, for example 5, 6, 7, 8, 9, 10, or 11 microns. A suitable SiO₂ is an untreated synthetic amorphous silica designed for use in aqueous systems.

In embodiments, the coating layer can be edible. For example, the coating layer can consist essentially of or consist solely of edible ingredients. Components for inclusion in such coating layers can be those designated as “Generally Recognized as Safe” (GRAS) by the United States Food and Drug Administration, and/or components with assigned, allowable E-numbers in the European Union, and/or components that are not yet designated as GRAS or E-numbered but have gone through proper testing and have been demonstrated as safe for human consumption in the amounts proposed for use in the coating layer. In embodiments, the substrate layer can be or include a foodstuff, e.g. a foodstuff for human consumption, or a foodstuff for animal consumption.

The coating layer can also be characterized by its melting point. In embodiments, the coating layer has a melting point in a range of about 40° C. to about 100° C., about 50° C. to about 90° C., or about 65° C. to about 85° C., for example about 40° C., about 50° C., about 60° C., about 65° C., about 70° C., about 75° C., about 80° C., about 85° C., about 90° C., or about 100° C.

In embodiments, the coating layer is free of plasticizers. Alternatively, in embodiments, the coating layer can include plasticizers. When included in the coating layer, the plasticizer can include, for example, water, glycerol, diglycerol, sorbitol, ethylene glycol, diethylene glycol, triethylene glycol, dipropylene glycol, tetraethylene glycol, propylene glycol, polyethylene glycols up to 400 MW, neopentyl glycol, trimethylolpropane (TMP), polyether polyols, 2-methyl-1,3-propanediol (e.g. MP Diol®), ethanolamines, isomalt, maltitol, xylitol, erythritol, adonitol, dulcitol, pentaerythritol, mannitol, and combinations of the foregoing.

In embodiments wherein the substrate layer and the coating layer each include plasticizers, the plasticizer of the substrate layer can be the same or different than the plasticizer of the coating layer. In some types of articles, when the plasticizer is included in the coating layer in an amount greater than, for example, about 40 wt %, based on the weight of the coating layer, the plasticizer can bleed and migrate into the substrate layer, which can affect the barrier properties of the coating layer, and the subsequent water-dispersible article. Thus, in embodiments wherein each of the coating layer and the substrate layer include a plasticizer, the coating layer optionally includes a plasticizer in an amount no greater than about 40 wt %, for example from about 1 wt % to about 40 wt %, about 5 wt % to about 35 wt %, about 10 wt % to about 30 wt %, or about 15 wt % to about 25 wt %, for example about 5, about 6, about 7, about 8, about 9, about 10, about 12, about 15, about 17, about 20, about 23, about 25, about 27, about 30, about 32, about 35, about 37, or about 40 wt %, based on the total weight of the coating layer. In some embodiments, it may be advantageous to include the plasticizer in the coating layer and/or substrate layer in an amount ranging from, for example, about 25 wt % to about 40 wt % to assist in the disintegration and dispersibility of the layer(s) and/or article. In other embodiments, it may be advantageous to include the plasticizer in the coating and/or substrate layer in an amount ranging from, for example, about 1 wt % to about 25 wt %, to slow the migration of plasticizer(s) and subsequent disintegration and dispersibility of the layer(s) and/or article.

The thickness of the coating layer is not particularly limited, insomuch as the coating layer has a thickness that is able to provide a suitable barrier to moisture for the substrate layer and subsequent article without peeling and/or cracking. Depending on the particular method of making the multilayer water-dispersible article (as well as the composition of each of the substrate and coating layer), as provided herein, in embodiments, the substrate layer and the coating layer are not necessarily each discrete layers in the multilayer article, such that the individual thicknesses of the coating layer and the substrate layer can be readily discerned. In some embodiments, wherein the coating layer is not a self-supporting layer and is applied to a surface of the substrate layer, the thickness of the coating layer may be negligible relative to the thickness of the substrate layer. However, in embodiments wherein the coating layer is applied to a surface of the substrate layer, and the thickness can be discerned, the coating layer can have a thickness ranging from about 0.5 μm to about 250 μm, about 1 μm to about 200 μm, about 10 μm to about 150 μm, about 50 to about 100, or about 1 μm to about 76 μm, about 5 μm to about 51 μm, or about 10 μm to about 25 μm, for example about 0.5, about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 24, about 25, about 30, about 35, about 40, about 45, about 50, about 51, about 52, about 53, about 54, about 55, about 60, about 70, about 71, about 72, about 73, about 74, about 75, about 76, about 80, about 85, about 90, about 95, about 100, about 110, about 120, about 130, about 140, about 150, about 160, about 170, about 180, about 190, about 200, about 210, about 220, about 230, about 240, or about 250 μm.

In embodiments, the substrate layer comprises an unmodified polyvinyl alcohol resin and the coating layer comprises beeswax and an emulsifying agent. In embodiments, the substrate layer comprises an anionic group-modified polyvinyl alcohol and the coating layer comprises beeswax and an emulsifying agent. In embodiments, the substrate layer comprises an unmodified polyvinyl alcohol resin and the coating layer comprises beeswax and polysorbate 80. In embodiments, the substrate layer comprises an anionic group-modified polyvinyl alcohol and the coating layer comprises beeswax and polysorbate 80.

### Multilayer Water-Dispersible Articles Including a Water-Soluble Polymer & a Wax

The disclosure further provides a multilayer water-dispersible article, such as a film, comprising a water-soluble polymer layer comprising a water-soluble polymer and a wax layer comprising a wax.

The water-soluble polymer can be any of those described herein for a substrate layer of the article. For example, in embodiments, the water-soluble polymer can include, but is not limited to, polyvinyl alcohol, polyacrylamide, poly(acrylic acid), poly(methacrylic acid), polyvinylpyrrolidone, quaternary ammonium polymers, a cellulose ether, and any mixture of any of the foregoing. In embodiments, the water-soluble polymer includes an unmodified polyvinyl alcohol. In embodiments, the water-soluble polymer includes an anionic group-modified resin modified with itaconic acid, monomethyl maleate, aminopropyl sulfonate, maleic acid, maleic anhydride, n-vinylpyrrolidone, n-vinylcaprolactam, a derivative of any of the foregoing, or a combination of any of the foregoing. For example, in embodiments, the water-soluble polymer includes a mixture of an unmodified polyvinyl alcohol and an anionic-group modified polyvinyl alcohol. In embodiments, the anionic group-modified polyvinyl alcohol comprises a polyvinyl alcohol modified with monomethyl maleate. In embodiments, the water-soluble polymer comprises a cellulose ether. Without intending to be bound by theory, it is believed that cellulose ethers can be useful not only as film/article-forming ingredients, but also as stabilizing agents and/or dissolution aids for the wax within the multilayer water-dispersible article. In embodiments, the water-soluble polymer comprises carboxymethylcellulose. In embodiments, the water-soluble polymer comprises a polyvinyl alcohol, such as an unmodified polyvinyl alcohol, and a cellulose ether, such as carboxymethylcellulose.

The viscosity, amount of modification, degree of hydrolysis, and other characteristics of the polyvinyl alcohol can be as described, above, for the polyvinyl alcohol used in the substrate layer. For example, in embodiments, the anionic group-modified polyvinyl alcohol comprises at least about 0.5 mol % anionic group modification, for example from about 1.0 mol % to about 4.0 mol % anionic group modification, or about 1.0 mol % to about 3.5 mol % anionic group modification. In embodiments, the polyvinyl alcohol (e.g., the unmodified and/or anionic group-modified polyvinyl alcohol) has a degree of hydrolysis of at least 88 mol %, for example in a range of about 90 mol % to less than 99 mol %. In embodiments, the polyvinyl alcohol has a 4% aqueous viscosity at 20° C. of at least about 6 cP, for example, about 6 cP, 8 cP, 10 cP, 12 cP, or 15 cP.

The wax can include a paraffin wax, microcrystalline wax, natural petroleum wax, synthetic petroleum wax, carnauba wax, candelilla wax, beeswax, and any mixture of any of the foregoing. In embodiments, the wax comprises a blend of two or more different waxes. In embodiments, the wax comprises a paraffin wax, a beeswax, or a combination thereof. The relative amounts of the waxes in the wax blend can be as described, above, for the wax in the coating layer. For example, in embodiments, the wax can comprise from about 10 wt % to about 90 wt % paraffin wax and from about 10 wt % to about 90 wt % beeswax, based on the total weight of the wax. In embodiments, the wax can consist of paraffin wax, beeswax, or a combination thereof. In embodiments, the wax comprises a wax emulsion. The wax emulsion can comprise from about 5 wt % to about 30 wt % wax, based on the total weight of the emulsion. That is, in embodiments when the wax comprises a wax blend of two waxes, and the wax blend is in the form of a wax emulsion, each of the two different waxes can be present in an amount ranging from about 10 wt % to about 90 wt % of the wax in the wax blend, and the wax blend can be present in an amount of about 5 wt % to about 30 wt % of the wax emulsion (i.e., each wax can be present in an amount ranging from about 0.5 wt % to about 27 wt % of the wax emulsion).

In embodiments, the wax is included in an amount of at least about 5 PHR and/or up to about 200 PHR In some embodiments, the wax can be included in the article in an amount of at least about 5, 6, 7, 8, 9, 10, 11, 12, 13, 14, 15, 16, 17, 18, 19, 20, 21, 22, 23, 24, 26, 26, 27, 28, 29, 30, 50, 75, 100, 115, 150, 170, 171, 172, 175, or 180, and/or up to about 200, 195, 190, 185, 180, 175, 174, 172, 170, 165, 160, 150, 116, 100, 75, 50, 45, 40, 30, 29, 28, 27, 26, 25, 24, 23, 22, 21, 20, 19, 18, 17, 16, 15, 14, 13, 12, 11, 10, 9, 8, 7, or 6 PHR. For example, in embodiments, the wax is present in an amount ranging from about 5 PHR to about 200 PHR, about 5 PHR to about 190 PHR, about 5 PHR to about 175 PHR, about 5 PHR to about 115 PHR, about 115 PHR to about 172 PHR, about 5 PHR to about 100 PHR, about 5 PHR to about 30 PHR, 5 PHR to about 29 PHR, about 5 PHR to about 28 PHR, about 5 PHR to about 25 PHR, about 5 PHR to about 22 PHR, about 5 PHR to about 20 PHR, about 5 PHR to about 18 PHR, about 5 PHR to about 15 PHR, about 5 PHR to about 12 PHR, about 5 PHR to about 10 PHR, about 5 PHR to about 7 PHR, 6 PHR to about 30 PHR, 6 PHR to about 29 PHR, about 6 PHR to about 28 PHR, about 6 PHR to about 25 PHR, about 6 PHR to about 22 PHR, about 6 PHR to about 20 PHR, about 6 PHR to about 18 PHR, about 6 PHR to about 15 PHR, about 6 PHR to about 12 PHR, about 6 PHR to about 10 PHR, about 6 PHR to about 7 PHR, about 7 PHR to about 30 PHR, about 7 PHR to about 28 PHR, about 7 PHR to about 25 PHR, about 7 PHR to about 22 PHR, about 7 PHR to about 20 PHR, about 7 PHR to about 18 PHR, about 7 PHR to about 15 PHR, about 7 PHR to about 12 PHR, about 7 PHR to about 10 PHR, about 7 PHR to about 8 PHR, about 10 PHR to about 30 PHR, about 10 PHR to about 29 PHR, about 10 PHR to about 28 PHR, about 10 PHR to about 25 PHR, about 10 PHR to about 22 PHR, about 10 PHR to about 20 PHR, about 10 PHR to about 18 PHR, about 10 PHR to about 15 PHR, about 10 PHR to about 12 PHR, about 12 PHR to about 30 PHR, about 12 PHR to about 28 PHR, about 12 PHR to about 25 PHR, about 12 PHR to about 22 PHR, about 12 PHR to about 20 PHR, about 12 PHR to about 18 PHR, about 12 PHR to about 16 PHR, about 12 PHR to about 14 PHR, about 12 PHR to about 13 PHR, about 15 PHR to about 30 PHR, about 15 PHR to about 28 PHR, about 15 PHR to about 25 PHR, about 15 PHR to about 22 PHR, about 15 PHR to about 20 PHR, about 15 PHR to about 18 PHR, about 15 PHR to about 16 PHR, about 18 PHR to about 30 PHR, about 18 PHR to about 28 PHR, about 18 PHR to about 25 PHR, about 18 PHR to about 22 PHR, about 18 PHR to about 20 PHR, about 20 PHR to about 30 PHR, about 20 PHR to about 28 PHR, about 20 PHR to about 25 PHR, about 20 PHR to about 22 PHR, about 22 PHR to about 30 PHR, about 22 PHR to about 28 PHR, about 22 PHR to about 25 PHR, about 22 PHR to about 24 PHR, about 25 PHR to about 30 PHR, about 25 PHR to about 28 PHR, about 25 PHR to about 27 PHR, about 28 PHR to about 30 PHR, or about 29 PHR to about 30 PHR. Without intending to be bound by theory, the amount of the wax in the article is believed to have a significant impact on the MVTR of the article. Alternatively, or additionally, the amount of the wax in the article can be described on a weight basis. In embodiments, the wax is present in an amount of at least about 5, 10, 15, 20, 15, 30, or 40 wt % and/or up to about 50, 45, 40, 35, 30, 25, 20, or 10 wt %, based on the total weight of the article. For example, the wax can be present in an amount ranging from about 5 wt % to about 50 wt %, about 10 wt % to about 45 wt %, about 15 wt % to about 40 wt %, about 20 wt % to about 35 wt %, or about 25 wt % to about 30 wt %, based on the total weight of a film.

The wax can have a melting point as described for the coating layer, above. For example, the wax can have a melting point ranging from about 40° C. to about 100° C., about 50° C. to about 90° C., about 60° C. to about 80° C., or about 65° C. to about 75° C.

In embodiments, the article can include a first face and a second face opposing the first face, wherein the first face comprises the polymer layer and the second face comprises the wax layer. In embodiments, the wax can form at least a portion of an exterior surface of the water-dispersible article. In embodiments, the wax can form at least a portion of the interior surface of the water-dispersible article. For example, in some embodiments wherein the article is a film in the form of a pouch defining an interior pouch volume for containing a composition, wherein the interior surface of the film faces the interior pouch volume and the exterior surface of the film opposes the interior surface, the wax can form at least a portion of the exterior surface of the pouch and/or at least a portion of the interior surface of the pouch (i.e., the surface in contact with the composition contained within the pouch). In embodiments, the wax can form at least a portion of each of the interior surface and the exterior surface of the article.

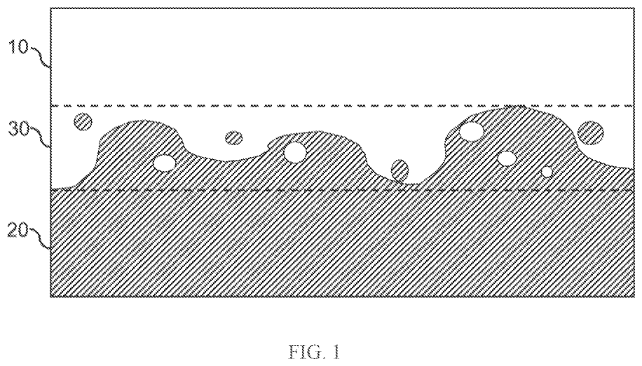

In embodiments, the article including a water-soluble polymer and a wax can be a multilayer water-dispersible article comprising a self-supporting article prepared from a composition comprising a mixture of the water-soluble polymer and the wax, wherein during the formation of the article, a portion of the wax migrates through the composition to a surface of the article, thereby providing an article wherein at least the portion of wax and the water-soluble polymer form opposing faces of the article. As shown in FIG. 1, the article can comprise a polymer layer 10 comprising a water-soluble polymer, a wax layer 20 comprising a wax, and an intermediate region 30 disposed between the polymer layer and the wax layer, the intermediate region comprising a mixture of the water-soluble polymer and the wax. Without intending to be bound by theory, it is believed that the wax is present as a separate phase that can be dispersed within or on top of the water-soluble polymer. When the portion of the wax blooms/migrates (e.g. phase separates) through the composition to a surface of the article, it can form a continuous or discontinuous “quasi” coating on the article. That is the article can have a surface wherein at least a portion of the surface is the wax, and at least a portion of the surface is the water-soluble polymer (e.g., the wax forms a discontinuous phase and the surface of the article can have exposed regions without a wax). In some cases, the wax can form a continuous “quasi” coating on the surface such that the entire surface of the article comprises the wax. In general, the wax can phase separate to one or more exterior surfaces of the article (e.g., one or both surfaces of a film). In embodiments, wherein the wax phase separates to two or more exterior surfaces of the article, the amount of wax at each surface can be the same (e.g., about 50 wt. % of the wax at each surface for a film, based on the total weight of the wax that phase separated) or can be different (e.g., substantial or preferential phase separation at one surface). In embodiments wherein the article has two exterior surfaces, the wax can phase separate to substantially one surface such that the wax and the polymer form opposing faces. As used herein, the wax phase separates to “substantially one surface” when the amount of wax at said surface comprises more than about half of the wax that phase separates, based on a comparison of the attenuated total reflectance (ATR-FTIR) signal strength for peaks associated with wax (e.g., CH₂ assymetric and symmetric vibrations in the 2850 to 2950 cm⁻¹ range) for each surface. Thus, an article can comprise wax phase on each surface and still be considered to have opposing faces comprising a polymer phase face and a wax phase face.

In embodiments, the article including a water-soluble polymer and a wax is a multilayer water-dispersible article comprising a substrate layer comprising the water-soluble polymer and a coating layer comprising the wax. Embodiments of this article, having a substrate and a coating layer, are described in detail, above.

The article can further include auxiliary agents or additional components. In embodiments, the polymer layer and/or the wax layer further comprises one or more of oxidized polyethylene, mineral oil, wood rosin, shellac, a triglyceride, linseed oil, corn oil, canola oil, hemp oil, coconut oil, unmodified polyvinyl alcohol, anionic group-modified polyvinyl alcohol, polyacrylamide, poly(acrylic acid), poly(methacrylic acid), polyvinylpyrrolidone, quaternary ammonium polymers, polyvinyl acetate, ethylene vinyl alcohol, alginate, a polysaccharide, a protein, a pH-adjusted protein, wood pulp, non-wood pulp, non-woven fiber, natural foam, synthetic foam, a derivative of any of the foregoing, or a mixture thereof. In embodiments, the article further comprises one or more of mineral oil, a triglyceride, linseed oil, corn oil, canola oil, hemp oil, coconut oil, a derivative of any of the foregoing, or a mixture thereof.

In embodiments, the polymer layer and/or the wax layer further comprises a plasticizer, a filler, a surfactant, an anti-block agent, an antioxidant, a slip agent, a dispersant, or a combination of any of the foregoing. Each of the plasticizer, filler, surfactant, anti-block agent, antioxidant, slip agent, dispersant, or combination thereof can be as described, above, for a water-dispersible article having a substrate layer and a coating layer. For example, in embodiments, the polymer layer and/or the wax layer further comprises a plasticizer, such as, glycerol, diglycerol, propylene glycol, ethylene glycol, diethylene glycol, triethylene glycol, a polyethylene glycole up to MW 400, sorbitol, 2-methyl-1,3-propanediol (MPD), ethanolamines, trimethylolpropane (TMP), a polyether polyol, isomalt, maltitol, xylitol, erythritol, adonitol, dulcitol, pentaerythritol, mannitol, or a combination of any of the foregoing. In embodiments, the polymer layer and/or the wax layer comprises xylitol, sorbitol, or a combination thereof. In embodiments, the polymer layer comprises a plasticizer and the plasticizer includes glycerol, sorbitol, xylitol, or a combination thereof.

In embodiments, the plasticizer, filler, surfactant, anti-block agent, antioxidant, slip agent, dispersant, or the combination thereof can be admixed with the water-soluble polymer.

In embodiments, the water-soluble polymer comprises a mixture of an unmodified polyvinyl alcohol resin and carboxymethylcellulose, and the wax comprises a wax emulsion comprising beeswax and polysorbate 80. In embodiments, the article comprises a water-dispersible film comprising an unmodified polyvinyl alcohol resin, carboxymethylcellulose, a wax emulsion comprising beeswax, polysorbate 80, and a plasticizer blend comprising glycerol, sorbitol, xylitol, or a combination thereof.

### Methods of Making Multilayer Water-Dispersible Article

The disclosure also relates to the manufacture of multilayer water-dispersible articles.

### Method A

Depending on the article and its application, the article can be formed using any known method, such as, for example, extrusion, blow extrusion, thermoforming, injection molding, dip molding, stretch molding, blow-molding, solvent casting, and the like.

In embodiments wherein the article is a water-dispersible film, the substrate layer can be formed through solvent casting, blow-molding, extrusion or blown extrusion. Processes for solvent casting of the substrate layer, which can include, for example, PVOH, are well-known in the art. For example, in the film-forming process of a PVOH layer, the polyvinyl alcohol resin(s) and secondary additives are dissolved in a solvent, typically water, metered onto a surface, allowed to substantially dry (or force-dried) to form a cast film, and then the resulting cast film is removed from the casting surface. The process can be performed batchwise, and is more efficiently performed in a continuous process.

In the formation of continuous films of polyvinyl alcohol, it is the conventional practice to meter a solution of the solution onto a moving casting surface, for example, a continuously moving metal drum or belt, causing the solvent to be substantially removed from the liquid, whereby a self-supporting cast film is formed, and then stripping the resulting cast film from the casting surface.

The process to form the coating layer can include melt blending. Processes for melt blending are well known in the art. For example, when the coating layer includes two or more waxes, the temperature at which the waxes are melted and blended together must be higher than the melting point of each of the waxes, but lower than the browning point of the waxes. Alternatively, or additionally, when the coating layer includes water-dispersible paraffin wax, oxidized polyethylene, microcrystalline wax, mineral oil, natural petroleum wax, synthetic petroleum wax, wood rosin, carnauba wax, candelilla wax, beeswax, shellac, a triglyceride, linseed oil, corn oil, canola oil, hemp oil, coconut oil, a derivative of any of the foregoing, or a mixture of any of the foregoing, the temperature at which the coating layer is mixed can be in a range of ambient room temperature to about 200° C. For example, the coating layer may be mixed at temperatures in a range of about 20° C. to about 200° C., about 25° C. to about 175° C., about 30° C. to about 150° C., about 25° C. to about 125° C., 40° C. to about 100° C., about 50° C. to about 90° C., or about 65° C. to about 85° C., for example about 20° C., about 25° C., about 30° C., about 35° C., about 40° C., about 50° C., about 60° C., about 65° C., about 70° C., about 75° C., about 80° C., about 85° C., about 90° C., about 100° C., about 115° C., about 120° C., about 125° C., about 130° C., about 140° C., about 150° C., about 160° C., about 170° C., about 180° C., about 190° C., or about 200° C.

In embodiments, the coating layer can be prepared as a solution and cast, as described above.

In embodiments, the multilayer water-dispersible article can be formed by, for example, solvent casting or extruding the substrate layer according to methods known in the art, and then contacting or applying the melt blended coating layer to one or more surfaces of the substrate layer, optionally followed by drying. The coating layer can be applied, for example, using a wire wound rod such as a Mayer rod, as is well known in the art. Alternative methods include spray coating, dip coating, spin coating, and flow coating, for example.

In embodiments, the multilayer water-dispersible article can be formed by, for example, solvent casting or extruding the substrate layer according to known methods in the art, and then processing the coating layer through a die and applying the coating layer to a surface of the substrate layer, optionally followed by drying. The coating layer can be melt blended or a solution, depending, in part, on its composition.

In embodiments, the multilayer water-dispersible article can be formed by preparing the substrate layer and coating layer independently, for example, through solvent casting and drying, and subsequently laminating the dried substrate layer to the dried the coating layer to provide a water-dispersible article.

The coating layer can be applied to the substrate layer in any weight suitable to prepare a multilayer article according to the disclosure. For example, the coating layer can have a coating weight ranging from about 5 g/m² to about 100 g/m², from about 10 g/m² to about 90 g/m², from about 20 g/m² to about 80 g/m², from about 30 g/m² to about 70 g/m², or from about 40 g/m² to about 60 g/m², for example about 8, about 10, about 13, about 15, about 17, about 20, about 22, about 25, about 28, about 30, about 32, about 35, about 38, about 40, about 42, about 45, about 47, about 50, about 52, about 55, about 57, about 60, about 62, about 65, about 67, about 70, about 72, about 75, about 77, about 80, about 85, about 90, about 95, or about 100 g/m².

In embodiments, the coating layer is applied to one surface of the substrate layer to provide a multilayer water-dispersible article having at least two layers, that is, a substrate layer and a coating layer. In embodiments, the substrate layer is coated on both surfaces of the substrate layer to provide a water dispersible article having three layers (i.e. a substrate layer between two opposite-facing coating layers). In embodiments, multiple coating layers having the same or different compositions can be applied to either face of the substrate layer to provide a multilayer article.

In embodiments, the substrate layer can be formed into, for example, a packet, a pouch, a bottle, or a box and subsequently coated with the coating layer by, for example, dip coating, spin coating, flow coating, and the like to provide the multilayer water-dispersible article. In embodiments, the multilayer water-dispersible article (including a substrate layer and a first coating layer) can be formed into, for example, a packet, a pouch, a bottle, or a box and subsequently coated with a second coating layer having the same or different composition as the first coating layer by, for example, dip coating, spin coating, flow coating, and the like to provide a coated multilayer water-dispersible article. In embodiments, the multilayer water-dispersible article is prepared such that the coating layer forms an interior surface of the article, and when the article is subsequently coated by, for example dip coating, the article comprises a coating layer-substrate layer-coating layer configuration. In embodiments, the multilayer water-dispersible article is prepared such that the coating layer forms an exterior surface of the article, and when the article is subsequently coated by, for example dip coating, the article comprises a substrate layer-coating layer configuration. The number of coating layers and the particular face of the substrate layer to which they are applied is not particularly limited.

### Method B

The multilayer water-dispersible articles of the disclosure can also be prepared by admixing the water-soluble polymer and a wax emulsion to provide a primary composition, and casting or extruding the primary composition to provide the multilayer water-dispersible article, wherein the water-dispersible article has a moisture vapor transmission rate (MVTR) of about 20 g H₂O/m²/day or less. The primary composition can be in the form of an emulsion. When the article is formed from the extrusion of the primary composition, the primary composition does not intentionally include water. That is, the primary composition may include residual water present in each of the components, but additional water is not intentionally added. Without intending to be bound by theory, it is believed that preparing the primary composition as an emulsion helps to maintain the wax and water-soluble phases.

The water-soluble polymer can be selected as provided herein. For example, in embodiments, the water-soluble polymer is selected from the group consisting of polyvinyl alcohol, polyacrylamide, poly(acrylic acid), poly(methacrylic acid), polyvinylpyrrolidone, quaternary ammonium polymers, a cellulose ether, and any mixture of any of the foregoing. In embodiments, the water-soluble polymer includes an unmodified polyvinyl alcohol. In embodiments, the water-soluble polymer includes an anionic group-modified resin modified with itaconic acid, monomethyl maleate, aminopropyl sulfonate, maleic acid, maleic anhydride, n-vinylpyrrolidone, n-vinylcaprolactam, a derivative of any of the foregoing, or a combination of any of the foregoing. For example, in embodiments, the water-soluble polymer includes a mixture of an unmodified polyvinyl alcohol and an anionic-group modified polyvinyl alcohol. In embodiments, the anionic group-modified polyvinyl alcohol comprises a polyvinyl alcohol modified with monomethyl maleate. In embodiments, the water-soluble polymer comprises a cellulose ether. For example, in embodiments, the water-soluble polymer comprises carboxymethylcellulose. In embodiments, the water-soluble polymer comprises a polyvinyl alcohol, such as an unmodified polyvinyl alcohol, and a cellulose ether, such as carboxymethylcellulose.

The viscosity, amount of modification, degree of hydrolysis, and other characteristics of the polyvinyl alcohol can be as described herein. For example, in embodiments, the anionic group-modified polyvinyl alcohol comprises at least about 0.5 mol % modification, for example from about 1.0 mol % to about 4.0 mol % modification, or about 1.0 mol % to about 3.5 mol % modification. In embodiments, the polyvinyl alcohol (e.g., the unmodified and/or anionic group-modified polyvinyl alcohol) has a degree of hydrolysis of at least 88 mol %, for example in a range of about 90 mol % to less than 99 mol %. In embodiments, the polyvinyl alcohol has a 4% aqueous viscosity at 20° C. of at least about 6 cP, for example, about 6 cP, 8 cP, 10 cP, 12 CP, or 15 cP.

As provided herein, the method comprises admixing the water-soluble polymer with a wax emulsion. The wax emulsion can include a paraffin wax, microcrystalline wax, natural petroleum wax, synthetic petroleum wax, carnauba wax, candelilla wax, beeswax, and any mixture of any of the foregoing. In embodiments, the wax emulsion comprises a blend of two or more different waxes. In embodiments, the wax emulsion comprises a paraffin wax, a beeswax, or a combination thereof. In embodiments, the wax emulsion comprises the paraffin wax, the beeswax, or the combination thereof in an amount ranging from about 5 wt % to about 30 wt %, based on the total weight of the wax emulsion, for example, about 10 wt % to about 25 wt %, about 10 wt % to about 15 wt %, about 15 wt % to about 30 wt %, about 20 wt % to about 30 wt %, or about 15 wt % to about 20 wt % In embodiments, the wax of the wax emulsion consists of paraffin wax, beeswax, or a combination thereof. In embodiments, the wax emulsion consists of paraffin wax, beeswax, or a combination thereof, an emulsifying agent, and a carrier solvent. In embodiments, the carrier solvent comprises water.

In embodiments, the emulsifying agent can be a nonionic surfactant, such as fatty acid esters of glycerol or fatty acid esters of sorbitol. Examples of suitable emulsifying agents include, but are not limited to, sorbitan monolaurate, sorbitan monostearate, sorbitan tristearate, polysorbate 20, polysorbate 40, polysorbate 60, polysorbate 80, glycerol monostearate, glycerol monolaurate, or any combination thereof. In embodiments, the emulsifying agent includes polysorbate 80.

The wax emulsion can be present in the admixture in an amount ranging from at least about 70, 80, 90, 95, 98, or 100 PHR and/or up to about 150, 140, 130, 120, 110, 100, 95, or 90 PHR, based on 100 parts by weight of the water-soluble polymer. In embodiments, the wax emulsion is present in the primary composition in an amount in a range of about 70 PHR to about 200 PHR, about 70 PHR to about 150 PHR, about 90 PHR to about 120 PHR, or about 95 PHR to about 115 PHR.

The wax emulsion and/or the primary composition can include additional ingredients, such as, for example, plasticizers, fillers, surfactants, anti-block agents, antioxidants, slip agents, dispersants, or any mixture thereof. Each of these additional ingredients can be selected and included as provided above. For example, in embodiments, the plasticizer includes glycerol, diglycerol, propylene glycol, dipropylene glycol, ethylene glycol, diethylene glycol, triethylene glycol, a polyethylene glycol up to MW 400, sorbitol, 2-methyl-1,3-propanediol (MPD), ethanolamines, trimethylolpropane (TMP), a polyether polyol, isomalt, maltitol, xylitol, erythritol, adonitol, dulcitol, pentaerythritol, mannitol, or a combination of any of the foregoing.

In embodiments, the plasticizer comprises sorbitol, xylitol, or a combination thereof. In embodiments, the method further comprises admixing the water-soluble polymer and the wax emulsion with one or more additional components in the group of a plasticizer, a filler, a surfactant, an anti-block agent, an antioxidant, a slip agent, and a dispersant to provide the primary composition.

The primary composition can further include auxiliary agents or additional components. In embodiments, the primary composition further comprises one or more of oxidized polyethylene, mineral oil, wood rosin, shellac, a triglyceride, linseed oil, corn oil, canola oil, hemp oil, coconut oil, unmodified polyvinyl alcohol, anionic group-modified polyvinyl alcohol, polyacrylamide, poly(acrylic acid), poly(methacrylic acid), polyvinylpyrrolidone, quaternary ammonium polymers, polyvinyl acetate, ethylene vinyl alcohol, alginate, a polysaccharide, a protein, a pH-adjusted protein, wood pulp, non-wood pulp, non-woven fiber, natural foam, synthetic foam, a derivative of any of the foregoing, or a mixture thereof.

In embodiments, the primary composition further comprises a plasticizer, a filler, a surfactant, an anti-block agent, an antioxidant, a slip agent, a dispersant, or a combination of any of the foregoing. Each of the plasticizer, filler, surfactant, anti-block agent, antioxidant, slip agent, dispersant, or combination thereof can be as described, above, for a water-dispersible article having a substrate layer and a coating layer. For example, in embodiments, the primary composition further comprises a plasticizer, such as, glycerol, diglycerol, propylene glycol, ethylene glycol, diethylene glycol, triethylene glycol, a polyethylene glycol up to MW 400, sorbitol, 2-methyl-1,3-propanediol (MPD), ethanolamines, trimethylolpropane (TMP), a polyether polyol, isomalt, maltitol, xylitol, erythritol, adonitol, dulcitol, pentaerythritol, mannitol, or a combination of any of the foregoing. In embodiments, the primary composition comprises xylitol, sorbitol, or a combination thereof. In embodiments, the plasticizer can be present in the primary composition in an amount in a range of about 10 PHR to about 25 PHR, based on 100 parts by weight of the water-soluble polymer.

The method includes admixing the water-soluble polymer and the wax emulsion. The temperature at which the water-soluble polymer and the wax emulsion are mixed can range from about 15° C. to about 100° C., about 20° C. to about 90° C., about 20° C. to about 85° C., or about 25° C. to about 70° C., for example about 15, 20, 25, 30, 35, 40, 45, 50, 55, 60, 65, 70, 75, 80, 85, 90, 95 or 100° C. The temperature at which the water-soluble polymer and wax emulsion are mixed will depend, in part, on the melting and/or browning temperatures of the wax, as described above. Furthermore, the temperature can also depend on the freezing point of the wax. If the mixing temperature is too low, the wax can freeze, causing it to precipitate or “crash out” of the emulsion.

The method further includes casting or extruding the primary composition to provide the multilayer water-dispersible article. In embodiments, the multilayer water-dispersible article can be formed by, for example, solvent casting the primary composition according to methods known in the art. In addition to casting, in embodiments, the article can be formed from the primary composition by extrusion. As used herein, the term “extrusion” includes extrusion and blown-extrusion. Methods of extrusion and blown-extrusion are known in the art. Upon casting or extruding, and without intending to be bound by theory, it is believed that the wax from the wax emulsion undergoes a “blooming effect” which causes the wax to migrate throughout the article (e.g., the film, etc.) to a surface of the article. Accordingly, the wax, having “bloomed” to a surface, can be present at least a portion of the interior and/or exterior surface of the article, thereby forming a continuous or discontinuous “quasi” coating on the article. Significantly, the thickness of the “coating” and/or “substrate” (formed, in part, by the water-soluble polymer) cannot be discerned, as the blooming of the wax is not necessarily uniform throughout the entire article.

In addition to casting and extrusion, in embodiments, the article can be formed from the primary composition by blow-molding, as known in the art.

### Packets/Pouches

The article according to the disclosure can be useful for containing a composition. The contained composition can take any form such as powders, gels, pastes, mulls, liquids, solids, tablets or any combination thereof (e.g. a solid suspended in a liquid). The article is also useful for any application in which improved wet handling, and low water vapor permeation are desired.

In embodiments wherein the multilayer water-dispersible article is a water-dispersible film, the film can form a pouch or a packet. Desirably, the water-dispersible film forms at least one side wall of the pouch, optionally the entire pouch. Thus, in some embodiments, the multilayer water-dispersible article is a water-dispersible film in the form of a pouch defining an interior pouch volume.

The multilayer water-dispersible article can also be a packet with two or more compartments made of the same substrate layer and/or coating layer compositions or in combination with articles of differing substrate layer and/or coating layer compositions. Additional articles can, for example, be obtained by casting, blow-molding, extrusion or blown extrusion of the same or a different polymeric material, as known in the art. In one type of embodiment, the polymers, copolymers or derivatives thereof suitable for use as the additional article are selected from polyvinyl alcohols, polyvinyl pyrrolidone, polyalkylene oxides, polyacrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthan, and carrageenans. For example, polymers can be selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and combinations thereof, or selected from polyvinyl alcohols, polyvinyl alcohol copolymers and hydroxypropyl methyl cellulose (HPMC), and combinations thereof. One contemplated class of embodiments is characterized by the level of polymer in the packet material, for example a PVOH copolymer being at least 60%.

The articles of the present disclosure can include at least one sealed compartment. Thus, the articles may comprise a single compartment or multiple compartments. In embodiments wherein the article is a water-dispersible film, the article can be formed from, for example, two layers of a water-dispersible multilayer film according to the disclosure, sealed at an interface, or by a single multilayer film that is folded upon itself and sealed. One or both of the films can include the water-dispersible film described herein. Accordingly, the sealed films define an article having an interior pouch container volume which contains any desired composition for release into an aqueous environment. The composition is not particularly limited, for example including any of the variety of compositions described below. In embodiments comprising multiple compartments, each compartment may contain identical and/or different compositions. In turn, the compositions may take any suitable form including, but not limited to liquid, solid, pressed solids (tablets) and combinations thereof (e.g. a solid suspended in a liquid). In embodiments, the articles comprise a first, second and third compartment, each of which respectively contains a different first, second, and third composition.

The compartments of multi-compartment articles may be of the same or different size(s) and/or volume(s). The compartments of the present multi-compartment pouches can be separate or conjoined in any suitable manner. In embodiments, the second and/or third and/or subsequent compartments are superimposed on the first compartment. The compartments may be packed in a string, each compartment being individually separable by a perforation line. Hence each compartment may be individually torn-off from the remainder of the string by the end-user.

In embodiments, the articles of the present disclosure can comprise one or more different films. For example, in single compartment embodiments, the packet may be made from one wall that is folded onto itself and sealed at the edges, or alternatively, two walls that are sealed together at the edges. In multiple compartment embodiments, the packet may be made from one or more films such that any given packet compartment may comprise walls made from a single film or multiple films having differing compositions.

Articles may be made using any suitable equipment and method. For example, single compartment pouches may be made using vertical form filling, horizontal form filling, or rotary drum filling techniques commonly known in the art Such processes may be either continuous or intermittent. The article, for example, may be dampened, and/or heated to increase the malleability thereof. The method may also involve the use of a vacuum, male plug assist, or forced air to draw or force the article into a suitable mold. The vacuum or forced air drawing the article into the mold can be applied for about 0.2 to about 5 seconds, or about 0.3 to about 3, or about 0.5 to about 1.5 seconds, once the article is on the horizontal portion of the surface. This vacuum or forced air can be such that it provides a pressure in a range of 10 mbar to 1000 mbar, or in a range of 100 mbar to 600 mbar, for example.

The molds, in which articles can be made, can have any shape, length, width and depth, depending on the required dimensions of the pouches. The molds can also vary in size and shape from one to another, if desirable. For example, the volume of the final articles may be about 5 ml to about 300 ml, or about 10 to 300 ml, or about 20 to about 300 ml, and that the mold sizes are adjusted accordingly. The articles of the disclosure may be of any size suitable for providing a unit dose. The size of the unit dose article will depend on the end application. For example, an article for a bulk water application such as a swimming pool may have an internal volume greater than about 25 ml and less than about 500 ml, such as 250 ml. For example, an article for a bulk water application such as a spa or hot tub may have an internal volume greater than 25 ml and less than about 200 ml, such as 100 ml. For example, an article for a baking application, such as for containing yeast may have an internal volume greater than 25 ml and less than about 100 ml, such as 50 ml. In embodiments, the article may have an internal volume of at least about 25 ml, or at least about 50 ml, or at least about 100 ml, or at least about 150 ml, or at least about 200 ml, or at least about 250 ml, or at least about 300 ml, and/or up to about 500 ml, up to about 400 ml, up to about 300 ml, up to about 200 ml, or up to about 100 ml. In embodiments, the contents of the article may be a powder in the form of a loose powder or a pressed tablet. The loose powder or pressed tablet may be provided in an amount of at least about 25 g, or at least about 100 g, or at least about 150 g, or at least about 200 g, or at least about 250 g, or at least about 300 g, or at least about 400 g, or at least about 500 g, or at least about 550 g, or at least about 600 g, for example in a range of about 100 g to about 600 g, or about 250 g to about 550 g, or about 500 g to about 600 g, or about 25 g to about 300 g. The articles of the disclosure may have a length of at least about 12.5 cm (about 5 inches), at least about 15.25 cm (about 6 inches), at least about 18 cm (about 7 inches), or at least about 23 cm (about 9 inches). In embodiments, the articles of the disclosure may have a width of at least about 7.5 cm (about 3 inches), at least about 10 cm (about 4 inches), or at least about 12.5 cm (about 5 inches). In embodiments, the articles may have a length of about 12.5 cm to about 15.25 cm (about 5 to about 6 inches) and a width of about 7.5 cm to about 10 cm (about 3 to about 4 inches).

In embodiments, the single compartment or plurality of sealed compartments contains a composition. The plurality of compartments may each contain the same or a different composition. The composition is selected from a liquid, solid or combination thereof.

In embodiments, the multilayer water-dispersible article can be disposed within a larger article, wherein the larger article can have the same or different composition as the article described herein. For example, in a baking application, a first multilayer water-dispersible article can contain within a sealed compartment thereof a composition comprising yeast, and the article can be disposed within a larger, second multilayer water-dispersible sealed article containing a composition comprising, for example, flour.

### Vertical Form, Fill, and Sealing of Multilayer Water-Dispersible Films

In embodiments wherein the water-dispersible article is a film, the water-dispersible film can be formed into a sealed article. In embodiments, the sealed article is a vertical form, filled, and sealed article, such as a pouch. The vertical form, fill, and seal (VFFS) process is a conventional automated process VFFS includes an apparatus such as an assembly machine that wraps a single piece of the film around a vertically oriented feed tube. The machine heat seals or otherwise secures the opposing edges of the film together to create the side seal and form a hollow tube of film. Subsequently, the machine heat seals or otherwise creates the bottom seal, thereby defining a container portion with an open top where the top seal will later be formed. The machine introduces a specified amount of flowable product into the container portion through the open top end Once the container includes the desired amount of product, the machine advances the film to another heat sealing device, for example, to create the top seal. Finally, the machine advances the film to a cutter that cuts the film immediately above the top seal to provide a filled package.

During operation, the assembly machine advances the film from a roll to form the package. Accordingly, the film must be able to readily advance through the machine and not adhere to the machine assembly or be so brittle as to break during processing.

The orientation of the substrate layer and coating layer in the sealed article are not particularly limited and can depend on the end-use of the article. For example, in embodiments, the substrate layer forms an exterior surface of the pouch and the coating layer forms an interior surface of the pouch. In embodiments, the substrate layer forms an interior surface of the pouch and the coating layer forms an exterior surface of the pouch. In embodiments wherein both surfaces of the substrate layer are in contact with a coating layer, the coating layer can form an interior and exterior surface of the pouch.

### Shaping, Sealing, and Thermoforming of Multilayer Water-Dispersible Films

In embodiments wherein the multilayer water-dispersible article is a film, the film can be thermoformable. A thermoformable film is one that can be shaped through the application of heat and a force. Water-dispersible films with relatively higher levels of plasticizer(s) in the substrate layer (e.g., about 20 wt. % to about 45 wt. %) are among those believed to be particularly suitable for such a process, while water-dispersible films with relatively lower levels of plasticizer(s) in the substrate layer (e.g., about 5 wt. % up to about 20 wt. %) can be thermoformed by controlling the thermoforming conditions, such as temperature, machine speed, dwell time, and the like.

Thermoforming a film is the process of heating the film, shaping it (e.g. in a mold), and then allowing the film to cool, whereupon the film will hold its shape, e.g. the shape of the mold. The heat may be applied using any suitable means. For example, the film may be heated directly by passing it under a heating element or through hot air, prior to feeding it onto a surface or once on a surface. Alternatively, it may be heated indirectly, for example by heating the surface or applying a hot item onto the film. In embodiments, the film is heated using an infrared light. The film can be heated to a temperature in a range of about 50 to about 260° C., about 50 to about 200° C., about 60 to about 150° C., about 70 to about 120° C., or about 60 to about 90° C. Without intending to be bound by theory, it is believed that the duration of heating should be inversely proportional to the heating temperature, so as to prevent browning of the substrate and/or coating layer. Thermoforming can be performed by any one or more of the following processes the manual draping of a thermally softened film over a mold, or the pressure induced shaping of a softened film to a mold (e.g., vacuum forming), or the automatic high-speed indexing of a freshly extruded sheet having an accurately known temperature into a forming and trimming station, or the automatic placement, plug and/or pneumatic stretching and pressuring forming of a film.

Alternatively, the film can be wetted by any suitable means, for example directly by spraying a wetting agent (including water, a solution of the film composition, a plasticizer for the film composition, or any combination of the foregoing) onto the film, prior to feeding it onto the surface or once on the surface, or indirectly by wetting the surface or by applying a wet item onto the film.

Once a film has been heated and/or wetted, it may be drawn into an appropriate mold, preferably using a vacuum. The filling of the molded film can be accomplished by utilizing any suitable means. In embodiments, the most preferred method will depend on the product form and required speed of filling. In embodiments, the molded film is filled by in-line filling techniques. The filled, open packets are then closed forming the pouches, using a second film, by any suitable method. This may be accomplished while in horizontal position and in continuous, constant motion. The closing may be accomplished by continuously feeding a second film, preferably water-dispersible film, over and onto the open packets and then preferably sealing the first and second film together, typically in the area between the molds and thus between the packets.

Any suitable method of sealing the packet and/or the individual compartments thereof may be utilized. Non-limiting examples of such means include heat sealing, solvent welding, solvent or wet sealing, and combinations thereof. Typically, only the area which is to form the seal is treated with heat or solvent. The heat or solvent can be applied by any method, typically on the closing material, and typically only on the areas which are to form the seal. In embodiments, the coating layer is not applied to surfaces of the material used to form the seal. That is, in embodiments, there can be uncoated substrate layers available for sealing such that the seal is formed between two surfaces of the substrate layer. For example, when the coating layer forms an interior surface of the article, the coating layer may not be applied to the outer edge of the substrate layer and/or any surface thereof used to form a seal. In some embodiments, the coating layer is applied to the entire substrate layer and can be used to form a seal. If solvent or wet sealing or welding is used, it may be preferred that heat is also applied. The temperatures at which the seals are formed can be in a range of about 240° F. (about 116° C.) to about 400° F. (about 204° C.), for example about 240 (about 116° C.), about 250 (about 121° C.), about 260 (about 127° C.), about 270 (about 132° C.), about 280 (about 138° C.), about 290 (about 143° C.), about 300 (about 149° C.), about 310 (about 154° C.), about 320 (about 160° C.), about 330 (about 166° C.), about 340 (about 171° C.), about 350 (about 177° C.), about 360 (about 182° C.), about 370 (about 188° C.), about 380 (about 193° C.), about 390 (about 199° C.), or about 400° F. (about 204° C.). Preferred wet or solvent sealing/welding methods include selectively applying solvent onto the area between the molds, or on the closing material, by for example, spraying or printing this onto these areas, and then applying pressure onto these areas, to form the seal Sealing rolls and belts as described above (optionally also providing heat) can be used, for example.

In embodiments, the sealed article can have a peel strength of at least 10 N, as measured by the Peel Strength Measurement test described herein.

The formed pouches may then be cut by a cutting device. Cutting can be accomplished using any known method. It may be preferred that the cutting is also done in continuous manner, and preferably with constant speed and preferably while in horizontal position. The cutting device can, for example, be a sharp item, or a hot item, or a laser, whereby in the latter cases, the hot item or laser ‘burns’ through the film/sealing area.

The different compartments of a multi-compartment pouches may be made together in a side-by-side style wherein the resulting, conjoined pouches may or may not be separated by cutting. Alternatively, the compartments can be made separately.

In embodiments, pouches may be made according to a process comprising the steps of: a) forming a first compartment (as described above); b) forming a recess within or all of the closed compartment formed in step (a), to generate a second molded compartment superposed above the first compartment; c) filling and closing the second compartments by means of a third film; d) sealing the first, second and third films, and e) cutting the films to produce a multi-compartment pouch. The recess formed in step (b) may be achieved by applying a vacuum to the compartment prepared in step (a).

In embodiments, second, and/or third compartment(s) can be made in a separate step and then combined with the first compartment as described in European Patent Application Number 08101442.5 or U.S. Patent Application Publication No. 2013/240388 A1 or WO 2009/152031.

In embodiments, pouches may be made according to a process comprising the steps of: a) forming a first compartment, optionally using heat and/or vacuum, using a first film on a first forming machine; b) filling the first compartment with a first composition; c) on a second forming machine, deforming a second film, optionally using heat and vacuum, to make a second and optionally third molded compartment; d) filling the second and optionally third compartments; e) sealing the second and optionally third compartment using a third film; f) placing the sealed second and optionally third compartments onto the first compartment; g) sealing the first, second and optionally third compartments; and h) cutting the films to produce a multi-compartment pouch.

The first and second forming machines may be selected based on their suitability to perform the above process. In embodiments, the first forming machine is preferably a horizontal forming machine, and the second forming machine is preferably a rotary drum forming machine, preferably located above the first forming machine.

It should be understood that by the use of appropriate feed stations, it may be possible to manufacture multi-compartment pouches incorporating a number of different or distinctive compositions and/or different or distinctive liquid, gel or paste compositions.

In embodiments, the film and/or pouch is sprayed or dusted with a suitable material, such as an active agent, a lubricant, an aversive agent, or mixtures thereof. In embodiments, the film and/or pouch is printed upon, for example, with an ink and/or an active agent.

### Contents of Multilayer Water-Dispersible Articles

The present articles (e.g., in the form of pouches, packets, bottles and the like) may contain various compositions, for example water-treatment compositions. A multi-compartment pouch may contain the same or different compositions in each separate compartment. The composition is proximal to an interior surface of the multilayer water-dispersible article. The composition may be less than about 10 cm, or less than about 5 cm, or less than about 1 cm, or less than about 1 mm, or less than about 0.1 mm from the surface of the article. Typically, the composition is adjacent to the surface of the article or in contact with the surface of the article. The article may be in the form of a pouch, a bottle, or a compartment, containing the composition therein.

In embodiments, a multilayer water-dispersible film according to the disclosure is formed into a sealed pouch, for example by VFFS, and encloses a composition. In embodiments, the multilayer water-dispersible article is a bottle, the bottle enclosing a composition. In embodiments, the composition is a liquid composition. In embodiments, the liquid composition has a high water content, that is, a water content above about 10 wt % based on the total weight of the composition. In embodiments, the composition is a dry composition. In embodiments, the composition is a chlorinated or brominated composition. In embodiments, the composition is a water-treatment agent. Such agents can include aggressive oxidizing chemicals, e.g. as described in U.S. Patent Application Publication No. 2014/0110301 and U.S. Pat. No. 8,728,593. For example, the agents can include hypochlorate salts such as sodium hypochlorite, calcium hypochlorite, and lithium hypochlorite; chlorinated isocyanurates such as dichloroisocyanuric acid (also referred to as “dichlor” or dichloro-s-triazinetrione, 1,3-dichloro-1,3,5-triazinane-2,4,6-trione) and trichloroisocyanuric acid (TCCA, also referred to as “trichlor” or 1,3,5-trichloro-1,3,5-triazinane-2,4,6-trione) or trichloroisocyanurate (TC); chlorates and perchlorates. Salts and hydrates of the agents are also contemplated. For example, dichloroisocyanuric acid may be provided as sodium dichloroisocyanurate, sodium dichloroisocyanurate acid dihydrate, among others. Bromine containing agents may also be suitable for use in unit dose packaging applications, such as brominated isocyanurates, bromates, perbromates, 1,3-dibromo-5,5-dimethylhydantoin (DBDMH), 2,2-dibromo-3-nitrilopropionamide (DBNPA), dibromocyano acetic acid amide, 1-bromo-3-chloro-5,5-dimethylhydantoin (BCDMH); and 2-bromo-2-nitro-1,3-propanediol, among others. Other suitable agents that can be included in the composition include, but are not limited to, perborates, periodates, persulfates, permanganates, chromates, dichromates, nitrates, nitrites, peroxides, ketone peroxides, peroxy acids inorganic acids, and combinations thereof.

In embodiments, the composition includes trichlorocyanuric acid (TCCA), dichloroisocyanuric acid, trichloroisocyanurate (TC), sodium bisulfate, sodium dichloroisocyanurate, sodium hypochlorite, calcium hypochlorite, lithium hypochlorite, sodium carbonate, sodium bicarbonate, cyanuric acid, 1-bromo-3-chloro-5,5-dimethylhydantoin (BCDMH), 2,2- dibromo-3-nitrilopropionamide (DBNPA), dibromocyano acetic acid amide, 2-bromo-2-nitro-1,3-propanediol, sodium perborate, potassium peroxymonosulfate, borax, potassium monopersulfate, citric acid, tartaric acid, polyacetic acid, ethylenediaminetetracetic acid, sodium chloride, calcium chloride, magnesium chloride, potassium chloride, glutaraldehyde, glyoxal, sodium sulfate, tripolypohosphate, tetrasodium pyrophosphate, multivalent metal salts, or combinations of the foregoing.

In another aspect, the composition can be edible. For example, the composition can consist essentially of or consist solely of edible ingredients. Components for inclusion in such compositions can be those designated as “Generally Recognized as Safe” (GRAS) by the United States Food and Drug Administration, and/or components with assigned, allowable E-numbers in the European Union, and/or components that are not yet designated as GRAS or E-numbered but have gone through proper testing and have been demonstrated as safe for human consumption in the amounts proposed for use in the composition. In embodiments, the composition is a foodstuff, e.g. a foodstuff for human consumption, or a foodstuff for animal consumption. In embodiments, the composition is a foodstuff that is hygroscopic, activates, or changes composition upon exposure to moisture, e.g., humidity. In embodiments, the composition includes yeast, sugar, salt, amylase, protease, lipase, flavoring aids, citric acid, tartaric acid, polyacetic acid, cinnamaldehyde, oats, bran, dried fruit, cheese, crackers, biscuits, or combinations of the foregoing.

In an embodiment, the composition can include detergent compositions such as liquid light duty and liquid heavy duty liquid detergent compositions, powdered detergent compositions, dish detergent for hand washing and/or machine washing; hard surface cleaning compositions, fabric enhancers, detergent gels commonly used for laundry, bleach and laundry additives, shaving creams, skin care, hair care compositions (shampoos and conditioners), and body washes. Such detergent compositions may comprise a surfactant, a bleach, an enzyme, a perfume, a dye or colorant, a solvent and combinations thereof.

In one type of embodiment, the composition can be a non-household care composition. For example, a non-household care composition can be selected from agricultural compositions, aviation compositions, food and nutritive compositions, industrial compositions, livestock compositions, marine compositions, medical compositions, mercantile compositions, military and quasi-military compositions, office compositions, and recreational and park compositions, pet compositions, water-treatment compositions, including cleaning and detergent compositions applicable to any such use while excluding fabric and household care compositions.

In one type of embodiment, the composition can include an agrochemical, e.g. one or more insecticides, fungicides, herbicides, pesticides, miticides, repellants, attractants, defoliaments, plant growth regulators, fertilizers, bactericides, micronutrients, and trace elements. Suitable agrochemicals and secondary agents are described in U.S. Pat. Nos. 6,204,223 and 4,681,228 and EP 0989803 A1. For example, suitable herbicides include paraquat salts (for example paraquat dichloride or paraquat bis(methylsulphate), diquat salts (for example diquat dibromide or diquat alginate), and glyphosate or a salt or ester thereof (such as glyphosate isopropylammonium, glyphosate sesquisodium or glyphosate trimesium, also known as sulfosate). Incompatible pairs of crop protection chemicals can be used in separate chambers, for example as described in U.S. Pat. No. 5,558,228. Incompatible pairs of crop protection chemicals that can be used include, for example, bensulfuron methyl and molinate; 2,4-D and thifensulfuron methyl:2,4-D and methyl 2-[[[[N-4-methoxy-6-methyl-1,3,5-triazine-2-yl)-N-methylamino]carbonyl]amino]-sulfonyl]benzoate, 2,4-D and metsulfuron methyl; maneb or mancozeb and benomyl; glyphosate and metsulfuron methyl; tralomethrin and any organophosphate such as monocrotophos or dimethoate; bromoxynil and N-[[4,6-dimethoxypyrimidine-2-yl)-amino]carbonyl]-3-(ethylsulfonyl)-2-pyridine-sulfonamide; bromoxynil and methyl 2-[[[[(4-methyl-6-methoxy)-1,3,5-triazin-2-yl)amino]carbonyl]amino]sulfonyl]-benzoate; bromoxynil and methyl 2-[[[[N-(4-methoxy-6-methyl-1,3,5-triazin-2-yl)-N-methylamino]carbonyl]amino]-sulfonyl]benzoate. In another, related, type of embodiment, the composition can include one or more seeds, optionally together with soil, and further optionally together with one or more additional components selected from mulch, sand, peat moss, water jelly crystals, and fertilizers, e.g. including types of embodiments described in U.S. Pat. No. 8,333,033.

Various other types of compositions are contemplated for use in the packets described herein, including particulates, for example down feathers, e.g. as described in U.S. RE29059 E; super absorbent polymers, e.g. as described in U.S. Patent Application Publication Nos. 2004/0144682 and 2006/0173430; pigments and tinters, e.g. as described in U.S. Pat. No. 3,580,390 and U.S. Patent Application Publication No. 2011/0054111; brazing flux (e.g. alkali metal fluoroaluminates, alkali metal fluorosilicates and alkali metal fluorozincates), e.g. as described in U.S. Pat. No. 8,163,104; food items (e.g., coffee powder or dried soup) as described in U.S. Patent Application Publication No. 2007/0003719; and wound dressings, e.g. as described in U.S. Pat. No. 4,466,431.

The pH of the pouch contents is not particularly limited, and the multilayer water-dispersible article can contain components that have a pH otherwise unsuitable for the water-soluble unit dose packages known and used in the art. For example, the article contents can have a pH ranging from about 3 to about 10, from about 3 to about 5.5, from about 8 to about 10, from about 4 to about 9, from about 5 to about 8, or from 6 to about 7, for example about 3, about 3.5, about 4, about 4.5, about 5, about 5.5, about 6, about 6.5, about 7, about 7.5, about 8, about 8.5, about 9, about 9.5, or about 10.

Where the PVOH films of the present disclosure are intended for uses in packaging formulations including harsh chemicals, as in an embodiment of the present disclosure, the packaged formulations are preferably designed to meet standards established by the relevant regulatory agencies and/or statutory or regulatory provisions, including, without limitation California Proposition 65 and New York State Department of Health. As such, amounts of any byproduct contaminants contained in the PVOH films of the present disclosure are well within such standards. For example, PVOH film contaminants can include 1,4-dioxane. As used herein, the terms “1,4-dioxane” and “dioxane” are used interchangeably. Dioxane can be present as a contaminant in certain film ingredients such as synthetic plasticizers and/or surfactants including ethylene oxide groups (e.g., oligomeric polyols, polyethylene glycols, polysorbates, and hydroxyethylated processed oils such as lauryl alcohol ethoxylate). Without intending to be bound by theory, it is believed that when an ethylene oxide containing surfactant or plasticizer is prepared, the ethylene oxide monomer is polymerized, during which, it is possible for some dioxane to be generated as a side product. The dioxane is then difficult to purify out of the surfactants and plasticizers and can remain as a minor impurity therein. Accordingly, the amount of dioxane present in the water soluble film can be limited by limiting the amount of ethylene oxide containing surfactants and plasticizers. In some embodiments, the surfactant used in the water soluble films can include less than 1 phr, less than 0.8 phr, or less than 0.5 phr of ethylene oxide containing surfactants. In some embodiments, the plasticizer used in the water soluble films can include less than 20 phr, less than 10 phr, less than 5 phr, or less than 1 phr of ethylene oxide containing plasticizers. In embodiments, the water soluble films disclosed herein can include less than 10 ppm dioxane. In embodiments, the water soluble films disclosed herein can include less than 5 ppm dioxane. In embodiments, the water soluble films disclosed herein can include about 0.0001 ppm to about 10 ppm dioxane, or about 0.0001 ppm to about 8 ppm, or about 0.0001 ppm to about 5 ppm, or about 0.0001 ppm to about 4 ppm, or about 0.0001 ppm to about 2 ppm, or about 0.0001 ppm to about 1 ppm, or about 0.001 ppm to about 2 ppm, or about 0.01 ppm to about 1 ppm.

### Moisture Vapor Transmission Rate (MVTR) Test

The multilayer water-dispersible article according to the disclosure can be characterized by the amount of moisture transmitted through the article, or layers thereof. The transmission of moisture through a layer or layers can be measured and described by the Moisture Vapor Transmission Rate (MVTR). The MVTR is measured as the daily mass of water transmitted per unit area of the barrier (g H₂O/m²/day).

The MVTR can be determined for each of the substrate layer, the coating layer, and the multilayer water-dispersible article.

The MVTR is measured using ASTM F-1249. Prior to testing, the samples are conditioned at 23° C. and 35% RH for at least 8 hours and no more than 48 hours, for example, about 24 hours. Measurements are made at about 38° C. and 50% RH, with the coating layer exposed to the water source.

In embodiments, the multilayer water-dispersible article can have a MVTR of about 300 g H₂O/m²/day or less, about 275 g H₂O/m²/day or less, about 250 g H₂O/m²/day or less, about 225 g H₂O/m²/day or less, about 200 g H₂O/m²/day or less, about 175 g H₂O/m²/day or less, about 150 g H₂O/m²/day or less, about 125 g H₂O/m²/day or less, about 100 g H₂O/m²/day or less, about 90 g H₂O/m²/day or less, about 80 g H₂O/m²/day or less, about 70 g H₂O/m²/day or less, about 60 g H₂O/m²/day or less, about 20 g H₂O/m²/day or less, or about 10 g H₂O/m²/day or less, for example, about 300 g H₂O/m²/day or less, about 250 g H₂O/m²/day or less, about 205 g H₂O/m²/day or less, about 100 g H₂O/m²/day or less, about 75 g H₂O/m²/day or less, about 60 g H₂O/m²/day or less, about 50 g H₂O/m²/day or less, about 40 g H₂O/m²/day or less, about 30 g H₂O/m²/day or less, about 22 g H₂O/m²/day or less, about 18 g H₂O/m²/day or less, about 16 g H₂O/m²/day or less, about 15 g H₂O/m²/day or less, about 14 g H₂O/m²/day or less, about 12H₂O/m²/day or less, about 10 g H₂O/m²/day or less, about 8 g H₂O/m²/day or less, about 7 g H₂O/m²/day or less, about 5 g H₂O/m²/day or less, about 3 g H₂O/m²/day or less, about 2.5 g H₂O/m²/day or less, about 1 g H₂O/m²/day or less, or about 0.5 g H₂O/m²/day or less. In embodiments, the water-dispersible article can have an MVTR in a range from about 0.05 g H₂O/m²/day to about 60 g H₂O/m²/day, about 0.05 g H₂O/m²/day to about 25 g H₂O/m²/day, about 0.05 g H₂O/m²/day to about 22 g H₂O/m²/day, about 0.05 g H₂O/m²/day to about 20 g H₂O/m²/day, about 0.05 g H₂O/m²/day to about 18 g H₂O/m²/day, about 0.10 g H₂O/m²/day to about 16 g H₂O/m²/day, about 0.15 g H₂O/m²/day to about 14 g H₂O/m²/day, about 0.50 g H₂O/m²/day to about 12 g H₂O/m²/day, about 0.75 g H₂O/m²/day to about 10 g H₂O/m²/day, about 10 g H₂O/m²/day to about 20 g H₂O/m²/day, about 12 g H₂O/m²/day to about 18 g H₂O/m²/day, about 14 g H₂O/m²/day to about 16 g H₂O/m²/day, about 0.05 g H₂O/m²/day to about 10 g H₂O/m²/day, about 1 g H₂O/m²/day to about 8 g H₂O/m²/day, about 2 g H₂O/m²/day to about 6 g H₂O/m²/day, or about 3 g H₂O/m²/day to about 5 g H₂O/m²/day, for example about 0.05, about 0.1, about 0.5, about 1, about 1.5, about 2, about 2.5, about 3, about 3.5, about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5 about 18, about 18.5, about 19, about 19.5, about 20, about 22, about 25, about 30, about 35, about 40, about 45, about 50, about 55, or about 60 g H₂O/m²/day. In embodiments wherein the composition contained within the article is a water-treatment containing, for example, harsh oxidizing chemicals, the MVTR of the water-dispersible article can range, for example, from about 4 g H₂O/m²/day to about 20 g H₂O/m²/day, from about 4 g H₂O/m²/day to about 18 g H₂O/m²/day, from about 4 g H₂O/m²/day to about 15 g H₂O/m²/day, from about 4 g H₂O/m²/day to about 12 g H₂O/m²/day, from about 4 g H₂O/m²/day to about 10 g H₂O/m²/day, from about 5 g H₂O/m²/day to about 9 g H₂O/m²/day, or from 6 g H₂O/m²/day to about 8 g H₂O/m²/day, for example about 4, about 4.5, about 5, about 5.5, about 6, about 6.5, about 7, about 7.5, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18, about 18.5, about 19, about 19.5, or about 20 g H₂O/m²/day. In embodiments wherein the composition contained within the article is water-sensitive, that is, it is hygroscopic or water-activated, the MVTR of the water-dispersible article can range for example from about 0.05 g H₂O/m²/day to about 10 g H₂O/m²/day, from about 0.1 g H₂O/m²/day to about 8 g H₂O/m²/day, from about 0.15 g H₂O/m²/day to about 6 g H₂O/m²/day, from about 0.05 g H₂O/m²/day to about 5 g H₂O/m²/day, from about 0.5 g H₂O/m²/day to about 4 g H₂O/m²/day, or from 1 g H₂O/m²/day to about 3 g H₂O/m²/day, for example about 0.05, about 0.1, about 0.5, about 1, about 1.5, about 2, about 2.5, about 3, about 3.5, about 4, about 4.5, about 5, about 5.5, about 6, about 6.5, about 7, about 7.5, about 8, about 8.5, about 9, about 9.5, or about 10 g H₂O/m²/day. In embodiments, the MVTR of the water-dispersible article can range, for example, from about 60 g H₂O/m²/day to about 300 g H₂O/m²/day, about 60 g H₂O/m²/day to about 250 g H₂O/m²/day, about 70 g H₂O/m²/day to about 205 g H₂O/m²/day, about 75 g H₂O/m²/day to about 200 g H₂O/m²/day, about 100 g H₂O/m²/day to about 200 g H₂O/m²/day, about 125 g H₂O/m²/day to about 175 g H₂O/m²/day, or about 140 g H₂O/m²/day to about 150 g H₂O/m²/day. Advantageously, articles having an MVTR in a range of about 60 g H₂O/m²/day to about 300 g H₂O/m²/day can provide membrane breathability that can allow moisture to enter and/or escape the article as needed One suitable example of such an article is a pouch prepared from the described film, where the pouch contains a desiccant (e.g., silica gel) packaged therein. The pouch can be included within the packaging of other goods that may be susceptible to water, such that as moisture infiltrates the packaging, it will be drawn into the pouch containing the desiccant through the film, thereby increasing the shelf-life, for example, of the packaged goods.

In general, the MVTR can be adjusted depending on the tolerance of the packaged composition(s) to water and/or moisture. For example, where the packaged composition is a food with a long shelf-life, an MVTR of up to about 300 g H₂O/m²/day may be suitable. Similarly, where the packaged composition is a food with a short shelf-life, an MVTR of less than about 60 g H₂O/m²/day may be suitable.

When provided as a discrete layer, or when the film is prepared from an admixture of the water-soluble polymer and the wax, the MVTR of the water-soluble polymer, film, or substrate layer, alone, can be in a range of about 10 g H₂O/m²/day to about 350 g H₂O/m²/day, about 50 g H₂O/m²/day to about 300 g H₂O/m²/day, about 100 g H₂O/m²/day to about 200 g H₂O/m²/day, or about 125 g H₂O/m²/day to about 175 g H₂O/m²/day, for example about 10, about 20, about 30, about 40, about 50, about 55, about 60, about 65, about 70, about 75, about 80, about 90, about 100, about 125, about 150, about 175, about 200, about 225, about 250, about 275, about 300, about 315, about 325, or about 350 g H₂O/m²/day Without intending to be bound by theory, it is believed that the MVTR can be variable with the thickness of such a layer. That is, as the polymer/substrate layer increases in thickness, the MVTR can decrease, and as the polymer/substrate layer decreases in thickness, the MVTR can increase.

In embodiments wherein the coating layer/wax is provided as a discrete layer, the coating layer/wax, alone, can have an MVTR that is at least about 0.05 g H₂O/m²/day less than the MVTR of the substrate layer. For example, the coating layer/wax, alone, can have an MVTR that is at least about 0.05, about 0.06, about 0.07, about 0.08, about 0.09, about 0.1, about 0.25, about 0.5, about 0.75, about 1.0, about 1.5, about 2, about 3, about 4, about 5, about 6, about 7, about 8, about 9, about 10, about 11, about 12, about 13, about 14, about 15, about 16, about 17, about 18, about 19, or about 20 g H₂O/m²/day less than the MVTR of the substrate layer.

When provided as a discrete layer, the MVTR of the coating layer/wax, alone, can be in a range up to about 20 g H₂O/m²/day or up to about 10 g H₂O/m²/day, for example the MVTR of the coating layer can be 0, about 0.05, about 0.1, about 0.25, about 0.5, about 0.75, about 1, about 2, about 3, about 4, about 5, about 6, about 7, about 8, about 9, about 10, about 11, about 12, about 13, about 14, about 15, about 16, about 17, about 18, about 19, or about 20 g H₂O/m²/day. Without intending to be bound by theory, it is believed that the MVTR can be variable with the thickness of the coating layer/wax. That is, as the coating layer/wax increases in thickness, the MVTR can decrease, and as the coating layer/wax decreases in thickness, the MVTR can increase.

Without intending to be bound by theory, it is believed the MVTR of the multilayer water-dispersible article depends on the compositions of both the substrate and coating layers, as well as the MVTR values of the substrate and coating layers, and/or the materials used to prepare the substrate and/or coating layers. That is, the MVTR of the water-dispersible multilayer article is not necessarily equal to the MVTR of the coating layer, i.e., the layer with the lowest theoretical MVTR. Significantly, when applied, the coating layer is not believed to provide a discrete or otherwise distinct layer in contact with the substrate layer. Instead, the coating layer can entangle, fuse, intertwine, blend, or otherwise associate with a surface of the substrate layer providing an interactive barrier on the substrate layer that can contribute, along with the substrate layer itself, to the moisture vapor transmission rate of the article. Accordingly, it is believed that the MVTR of the resultant multilayer article is dependent on the MVTR of both the substrate layer and coating layer, and also the materials and compositions used to form said layers.

### Clarity/Yellowness

The water-dispersible multilayer article can be characterized by its clarity and/or yellowness. In particular, the article can be characterized by its clarity and/or yellowness after conditioning for 8 weeks in a 38° C., 80% RH environment. The clarity and/or yellowness of the article is determined by the absolute b* values using the L*a*b* color scale by measuring spectral excluded (SPEX) using an F12 illuminant and a 10° Standard Observer, as is well known in the art.

In embodiments, the water-dispersible multilayer article has an absolute b* value of 5 or less after conditioning for 8 weeks in a 38° C., 80% RH environment. For example, the water-dispersible multilayer article can have an absolute b* value of, for example, 0, about 0.1, about 0.25, about 0.5, about 0.75, about 1.0, about 1.25, about 1.5, about 1.75, about 2.0, about 2.5, about 2.75, about 3, about 3.25, about 3.5, about 3.75, about 4.0, about 4.25, about 4.5, about 4.75 or about 5.0. In embodiments, the absolute b* value does not exceed about 3.75 after conditioning for 8 weeks in a 38 C, 80% RH environment. In embodiments, the absolute b* value does not exceed about 2.5 after conditioning for 8 weeks in a 38 C, 80% RH environment.

The absolute b* value can be converted to the traditional yellowness index (YI) values, by using a method such as that described in ASTM E313-15 “Standard Practice for Calculating Yellowness and Whiteness Indices from Instrumentally Measured Color Coordinates.”

### Coefficient of Friction (COF) Test

The Coefficient of Friction method tests the friction of two pieces of material that are rubbed against each other; the force required to move one piece against the other is measured. The force to start the sled (static friction) and the force to keep the sled moving (dynamic friction) are both measured by the load cell using ASTM D1894 “Friction Testing of Plastic Film and Sheeting.” The COF can be measured for the substrate layer, alone, the coating layer, alone, or an article comprising both a substrate layer and a coating layer.

The test as described herein is for use to measure the COF of the coating layer surface of the articles according to the disclosure, such as films. The method uses an Instron® Coefficient of Friction Testing Fixture Model 2810-005, or equivalent, a representative diagram of which is shown in FIG. 2, and an Instron® Testing Machine Model #5543, or equivalent.

The testing apparatus includes a friction fixture 10 upon which rests a friction sled 12 having secured thereon a film sample 14 The sled 12 is coupled to the upper grip 18 via a pull cord 20 which engages with pulley 22 secured to the friction fixture 10. The lower coupling 24 secures the testing fixture to the Instron® testing machine (not shown).

According the Instron® method Blue Hill program: “The system: searches the data from the start value to the end value on the specified channel for the maximum value; determines the first data point that rises and falls by the percentage of the maximum value and assigns this point as the first peak; uses the following equation to determine the coefficient of static friction: static friction=first peak/sled weight; uses the following equation to calculate the average load of the area from the first peak to the end value: average load=energy/change in extension; and uses the following equation to determine the coefficient of dynamic friction: dynamic friction=average load/sled weight.”

The test specimen shall consist of samples having dimensions (5 inch by 5 inch square (12.7 cm by 12.7 cm square) for the sled and 5 inch by 8 inch rectangle (12.7 cm by 20.3 cm) for the surface, to form a testing area. While it is believed that the film thickness will not affect the Static COF, the film can have a thickness of 3.0 t 0.1 mil (or 76 2±2.5 μm). The samples can be cut using a razor blade and templates of the appropriate dimensions, for example. When applicable, the sample should be cut with the long dimension parallel to the machine direction of the cast film. Again when applicable, the 5 inch×5 inch sample direction should be noted and oriented in the test so that the direction the sled is being pulled is parallel to the machine direction of the film sample.

The test specimen shall be conditioned at 75° F.±5° F. and relative humidity 35%±5% for not less than 8 hours prior to the test, and the test is conducted at the same temperature and relative humidity conditions.

Installation Procedure of COF Apparatus
1. Remove the clevis pin from the lower jaw on the Instron® Coefficient of Friction Testing Fixture Model 2810-005, and remove.
2. Remove the clevis pin from the upper jaw, and remove.
3. Place the friction fixture lower coupling onto the base adapter of the Instron® Testing Machine Model #5543.
4. Fit it with the clevis pin.
5. Slip the loop of one end of the pull cord onto the upper clevis pin, and replace the locking clip.
6. Calibrate Testing Machine Model #5543
7. Slip the loop on the other end of the pull cord onto the friction sled hook.
8. Make sure the pulley is able to spin freely
9. Move the sled till the pull cord has no slack and is oriented in the groove around the pulley
10. Position the moving crosshead (upper heard) of the Instron® Coefficient of Friction Testing Fixture Model 2810-005 so that there is sufficient travel space to draw the friction sled along the full 50 mm of the test without running the sled into the pulley.
11 Keep the cord taut while the crosshead is moving
12. Using the JOG control on the Instron #5543 control panel, set the extension limit so that the far end of the friction sled does not exceed the back plane (the plane perpendicular to the axis of motion, and furthest from the pulley) of the friction fixture. Press the GL button to set the travel limit. This prevents the friction sled from colliding with the pulley during the test, and insures that the coefficient of friction of the sample of interest is properly measured.
13. The test fixture is now ready for testing.

Placement of Specimen Procedure
1. Place the surface sample on the aluminum friction fixture in the appropriate orientation.
2. Pull the surface sample tight over the edges of the aluminum surface and tape the sample on the bottom side of the friction fixture.
3. It is important to tape along the end of the friction fixture furthest from the coupling to avoid binding of the sled on the surface.
4. Make sure that the material is taut but not stretched.
5. Wrap the friction sled with the 5×5 inch sample
6. Tape the leading edge overlap on the top of the sled making sure there is no excess material which will bind up on the surface sample.
7. Tape the other edges of the sample on the friction sled to ensure the sample is taut on the contact surface being measured.
8. Be sure that no tape will get between the surface of interest on the sled and on the friction fixture.
9. The samples on the friction surface and on the friction sled should be taut with no wrinkles or bulges, these will cause errors in measuring the COF.
10. Inspect the sled to be sure there are no foreign materials touching the surfaces being tested
11. Attach the sled to the pull cord and place the sled very lightly and gently on the friction table in order to prevent any unnatural bond from developing between the two specimens, begin test promptly.
12. Be sure that at full extension the sled sits completely over the sample placed on the friction fixture and does not contact tape or hang over the edge of the friction fixture.

Performing the COF Test
1. Test not less than three specimens per requested orientation (for example, coating layer side or substrate layer side).
2. The coating layer side orientation of the film should be the film sample placed on the aluminum test surface, and the substrate layer side for testing should comprise the material wrapped around the sled.
3. Be sure to wear powder-free, moisture barrier gloves while handling the film specimens; powder or moisture may compromise the accuracy of the test.
4. Cut a sample as described above, e.g. using a template.
5. Place the friction sled wrapped in the first specimen at the end of the friction fixture furthest from the pulley.
6. Make sure the pull cord is pulled taut.
7. Open the Coefficient of Friction test titled “COF.im ptf” from the testing screen
8. Click the start button on the screen to begin the test.
9. Upon completion of the specimen test run, click ok and return the friction sled to the starting position and change the film specimen on the friction sled and the fixture. Repeat the test.

The article can be characterized by a static COF in a range of 4.0 or less, or 2.0 or less, or 1.5 or less, or 1.25 or less, or 1.0 or less, for example 1.0, 0.9, 0.8, 0.7, 0.6, or even less. In another aspect, the static COF can be less than 4.0, or less than about 2.4, or less than 2, or less than 1.

In one aspect, the article can be characterized by having a Static COF less than 0.45, a tensile strength in a range of 40 to 60 MPa and a tear strength in a range of 1000 to 2100 g/mil, or 1150 to 2100 g/mil.

### Peel Strength Measurements

As described, the multilayer water-dispersible article according to the disclosure can be a film. The multilayer film can be heat sealable. As used herein, the term “heat sealable” is characterized by the multilayer film having a peel strength of at least 10 N. A peel strength of at least 10 N indicates film failure, that is, breakage or tearing of the film rather than peeling apart of the sealed films.

Peel Strength Measurements were collected using MSTM-133, which incorporates ASTM D 1876 (T-Peel test) and ASTM D 903-98.

For peel strength determination, test specimens are prepared by cutting six 4″×5″ film sheets. One sheet, with the matte surface facing upward, is overlaid with another sheet so that the two matte surfaces are in contact with each other. This yields a matte-matte orientation. The film (comprising the two sheets) is inserted into the jaws of a TS-12 Heat Sealer and sealed at the appropriate heat seal temperature. To determine the appropriate heat seal temperature for a particular film, multiple samples are cut and analyzed over a range of temperatures for the Heat Sealer. The samples are analyzed at temperatures in increasing increments of 5° F. to 10° F. (2.8° C. to 5.6° C.). Sealing is repeated until a temperature is reached that produces a quality seal. A quality seal can be characterized in that the two sheets do not easily peel apart using force by hand, and the sheets do not bubble or burn at the seal. When a quality seal is produced, specimens are prepared for all orientations, such as matte to matte, gloss to gloss, and matte to gloss.

For the peel test, there is a 0.25″ (0.39 cm) separation between the rubber grips, all four of which are flat and square. Three (or more) 1″-wide (2.54 cm) samples are cut in the machine direction (MD). The unsealed flaps of each sample are placed in the grips of the testing machine, taking care to ensure that the specimen is aligned with the grips and parallel to them, and that the specimen is not pulled too tightly in the tester's jaws. The load is balanced and the test is initiated according to the instructions of the equipment manufacturer. At the end of the test, the tensile force (in N) required to tear or separate the layers is recorded as the peel strength. Similarly, for tensile strength, three (or more) 1″-wide (2.54 cm) single sheet samples are mounted into the tensile testing machine and analyzed to determine the film peak strength (in N).

### Tensile Strength Test and Elongation Test (ASTM D 882)

Furthermore, when the water-dispersible article according to the disclosure is in the form of a film, the film can be characterized by or tested for tensile strength according to the Tensile Strength Test and elongation at break according to the Elongation Test is analyzed as follows. The procedure includes the determination of Tensile Strength and the determination of elongation at break according to ASTM D 882 (“Standard Test Method for Tensile Properties of Thin Plastic Sheeting”) or equivalent. An INSTRON® tensile testing apparatus (Model 5544 Tensile Tester or equivalent) is used for the collection of film data. A minimum of three test specimens, each cut with reliable cutting tools to ensure dimensional stability and reproducibility, are tested in the machine direction (MD) (where applicable) for each measurement. Tests are conducted in the standard laboratory atmosphere of 23±2.0° C. and 35±5% relative humidity. For tensile strength or elongation at break determination. 1″-wide (2.54 cm) samples of a single film sheet having a thickness of 3.0±0.15 mil (or 76.2±3.8 μm) are prepared. The sample is then conditioned for 8 weeks at 38° C. 80% RH. The sample is then transferred to the INSTRON® tensile testing machine to proceed with testing while minimizing exposure in the 35% relative humidity environment. The tensile testing machine is prepared according to manufacturer instructions, equipped with a 500 N load cell, and calibrated. The correct grips and faces are fitted (INSTRON® grips having model number 2702-032 faces, which are rubber coated and 25 mm wide, or equivalent). The samples are mounted into the tensile testing machine and analyzed to determine the elongation at break (i.e., where Young's Modulus applies) and Tensile Strength (i.e., stress required to break film).

Suitable behavior of films according to the disclosure is marked by Tensile Strength values (in the machine direction (MD)) of at least about 20 MPa as measured by the Tensile Strength Test. In various embodiments, the film has a Tensile Strength value of at least 20 MPa and/or up to about 100 MPa (e.g., about 20, about 40, about 60, about 80 or about 100 MPa).

Suitable behavior of films according to the disclosure is marked by Elongation at break values (in the machine direction) of at least about 50% as measured by the INSTRON® testing machine. In various embodiments, the film has an Elongation at break value of at least 50% and/or up to about 700% (e.g., about 50%, about 100%, about 200%, about 225%, about 250%, about 300% about 400%, about 425%, about 450%, about 475%, about 500%, about 600%, or about 700%).

### Chemical Stability Test

The compatibility of water-dispersible articles to chemicals can be determined by evaluating dispersibility of the article after exposure to chemicals. Multilayer water-dispersible articles are prepared to a desired thickness and pouches comprising a chemical composition in contact with the article are formed according to any suitable process, e.g., vertical form, fill, and sealing, injection molding, filling and sealing, or thermoforming and sealing, as described above.

The articles containing the chemical composition are stored under ambient conditions (23° C. and 35% RH), at 38° C. and 10% relative humidity (RH), or at 38° C. at 80% RH. The conditions can be chosen to simulate actual storage conditions of unit dose articles. Samples are stored for 14 days (2 weeks), 28 days (4 weeks), 42 days (6 weeks), and 56 days (8 weeks).

After the desired storage time has passed, the stability of the article to the chemical composition is determined by measuring the disintegration and dissolution time using MSTM 205, described below.

### Dissolution and Disintegration Test (Modified MSTM 205)

An article can be characterized by or tested for Dissolution Time and Disintegration Time according to a modified MonoSol Test Method 205 (MSTM 205), a method known in the art. See, for example, U.S. Pat. No. 7,022,656.

Apparatus and Materials:

1. 500 mL Beaker

2. Magnetic Stirrer (Labline Model No. 1250 or equivalent)

3. Magnetic Stirring Rod (5 cm)

4. Thermometer (0 to 100° C.±1° C.)

5. Template, Stainless Steel (3.8 cm×3.2 cm)

6. Timer (0-300 seconds, accurate to the nearest second)

7. Polaroid 35 mm slide Mount (or equivalent)

8. MonoSol 35 mm Slide Mount Holder (or equivalent)

9. Distilled water

For each article to be tested, three test specimens are cut from an article sample using stainless steel template (i.e., 3.8 cm×3.2 cm specimen). If cut from a film web, specimens should be cut from areas of web evenly spaced along the transverse direction of the web. Each test specimen is then analyzed using the following procedure.

1. Lock each specimen in a separate 35 mm slide mount.

2. Fill beaker with 500 mL distilled water. Measure water temperature with thermometer and, if necessary, heat or cool water to maintain temperature at 20° C. (68° F.).

3. Mark height of column of water. Place magnetic stirrer on base of holder. Place beaker on magnetic stirrer, add magnetic stirring rod to beaker, turn on stirrer, and adjust sur speed until a vortex develops which is approximately one-fifth the height of the water column. Mark depth of vortex.

4. Secure the 35 mm slide mount in the alligator clamp of the 35 mm slide mount holder such that the long end of the slide mount is parallel to the water surface. The depth adjuster of the holder should be set so that when dropped, the end of the clamp will be 0.6 cm below the surface of the water. One of the short sides of the slide mount should be next to the side of the beaker with the other positioned directly over the center of the stirring rod such that the article surface is perpendicular to the flow of the water.

5. In one motion, drop the secured slide and clamp into the water and start the timer. Disintegration occurs when the article breaks apart. After 300 seconds, raise the slide out of the water while continuing to monitor the solution for undissolved article fragments. Dissolution occurs when all article fragments are no longer visible and the solution becomes clear. If the film has not completely dissolved from the slide, please note the approximate percent (%) surface area of the film left intact in the slide: 0-25%, 25-50%, 50-75%, or 75-100%. This is referred to as the Percent Residue (%).

The results should include the following: complete sample identification; individual and average disintegration and dissolution times: and water temperature at which the samples were tested.

Article disintegration times (1) and article dissolution times (S) can be corrected to a standard or reference article thickness using the exponential algorithms shown below in Equation 1 and Equation 2, respectively.

I_{corrected}=I_{measured}×(reference thickness/measured thickness)^{1.93} [1]

S_{corrected}=S_{measured}×(reference thickness/measured thickness)^{1.83} [2]

Specifically contemplated embodiments of the disclosure are herein described in the following numbered paragraphs. These embodiments are intended to be illustrative in nature and not intended to be limiting.

A multilayer water-dispersible article, optionally a film, comprising a polymer layer comprising a water-soluble polymer and a wax layer comprising a wax, wherein the wax is present in an amount ranging from about 5 PHR to about 200 PHR, based on 100 parts by weight of the water-soluble polymer, and the water-dispersible article has a moisture vapor transmission rate (MVTR) of about 60 g H₂O/m²/day to about 300 g H₂O/m²/day.

The multilayer water-dispersible article of paragraph [00184], wherein the wax is selected from the group consisting of paraffin wax, microcrystalline wax, natural petroleum wax, synthetic petroleum wax, carnauba wax, candelilla wax, beeswax, and any mixture of any of the foregoing.

The multilayer water-dispersible article of paragraphs [00184] or [00185], wherein the polymer layer or wax layer further comprises one or more of oxidized polyethylene, mineral oil, wood rosin, shellac, a triglyceride, linseed oil, corn oil, canola oil, hemp oil, coconut oil, unmodified polyvinyl alcohol, anionic group modified polyvinyl alcohol, polyacrylamide, poly(acrylic acid), poly(methacrylic acid), polyvinylpyrrolidone, quaternary ammonium polymers, polyvinyl acetate, ethylene vinyl alcohol, alginate, a polysaccharide, a protein, a pH-adjusted protein, wood pulp, non-wood pulp, non-woven fiber, natural foam, synthetic foam, and a derivative of any of the foregoing.

The multilayer water-dispersible article of any one of paragraphs [00184] to [00186], wherein the water-soluble polymer comprises polyvinyl alcohol, polyacrylamide, poly(acrylic acid), poly(methacrylic acid), polyvinylpyrrolidone, quaternary ammonium polymers, a cellulose ether, or any mixture of any of the foregoing.

The multilayer water-dispersible article of paragraph [00187], wherein the water-soluble polymer comprises an unmodified polyvinyl alcohol.

The multilayer water-dispersible article of paragraph [00187] or [00188], wherein the water-soluble polymer comprises an anionic group-modified polyvinyl alcohol resin modified with one or more in the group of itaconic acid, monomethyl maleate, aminopropyl sulfonate, maleic acid, maleic anhydride, n-vinylpyrrolidone, n-vinylcaprolactam, and a derivative of any of the foregoing.

The multilayer water-dispersible article of paragraph [00189], wherein the anionic group-modified polyvinyl alcohol comprises a polyvinyl alcohol modified with monomethyl maleate.

The multilayer water-dispersible article of paragraph [00189] or [00190], wherein the anionic group-modified polyvinyl alcohol comprises at least 0.5 mol % anionic group modification.

The multilayer water-dispersible article of any one of paragraphs [00189] to [00191], wherein the anionic group-modified polyvinyl alcohol comprises from about 1.0 to about 4.0 mol % anionic group modification.

The multilayer water-dispersible article of any one of paragraphs [00189] to [00192], wherein the anionic group-modified polyvinyl alcohol comprises from about 1.0 to about 3.5 mol % anionic group modification.

The multilayer water-dispersible article of any one of paragraphs [00187] to [00193], wherein the polyvinyl alcohol has a degree of hydrolysis of at least 88 mol %.

The multilayer water-dispersible article of any one of paragraphs [00187] to [00194], wherein the polyvinyl alcohol has a degree of hydrolysis in a range from 90 mol % to less than 99 mol %.

The multilayer water-dispersible article of any one of paragraphs [00187] to [00195], wherein the polyvinyl alcohol has a 4% aqueous viscosity at 20° C. of at least about 6 cP.

The multilayer water-dispersible article of any one of paragraphs [00187] to [00196], wherein the water-soluble polymer comprises a cellulose ether.

The multilayer water-dispersible article of paragraph [00197], wherein the cellulose ether comprises carboxymethylcellulose.

The multilayer water-dispersible article of any one of paragraphs [00184] to [00198], wherein the article comprises a first face and a second face opposing the first face, wherein the first face comprises the polymer layer and the second face comprises the wax layer.

The multilayer water-dispersible article of any one of paragraphs [00184] to [00199], wherein the water-dispersible article is in the form of a pouch defining and interior pouch volume having an interior surface facing the interior pouch volume and an exterior surface opposing the interior surface, and the wax layer forms at least a portion of the exterior surface of the pouch.

The multilayer water-dispersible article of any one of paragraphs [00184] to [00200], wherein the water-dispersible article is in the form of a pouch defining and interior pouch volume having an interior surface facing the interior pouch volume and an exterior surface opposing the interior surface, and the wax layer forms at least a portion of the interior surface of the pouch.

The multilayer water-dispersible article of any one of paragraphs [00184] to [00201], comprising an intermediate region disposed between the polymer layer and the wax layer, the intermediate region comprising a mixture of the water-soluble polymer and the wax.

The multilayer water-dispersible article of any one of paragraphs [00184] to [00202], wherein the polymer layer or the wax layer further comprises a plasticizer.

The multilayer water-dispersible article of paragraph [00203], wherein the plasticizer comprises glycerol, diglycerol, propylene glycol, dipropylene glycol, ethylene glycol, diethylene glycol, triethylene glycol, a polyethylene glycol up to MW 400, sorbitol, 2-methyl-1,3-propanediol, ethanolamines, trimethylolpropane (TMP), a polyether polyol, isomalt, maltitol, xylitol, erythritol, adonitol, dulcitol, pentaerythritol, mannitol, or a combination of any of the foregoing.

The multilayer water-dispersible article of any one of paragraphs [00184] to [00204], wherein the polymer layer or the wax layer further comprises a filler, a surfactant, an anti-block agent, an antioxidant, a slip agent, a dispersant, or a combination of any of the foregoing.

The multilayer water-dispersible article of paragraphs [00204] to [00205] wherein the plasticizer, the filler, the surfactant, the anti-block agent, the antioxidant, the slip agent, the dispersant, or the combination of any of the foregoing is admixed with the water-soluble polymer.

The multilayer water-dispersible article of any one of paragraphs [00184] to [00206], wherein the wax comprises a wax emulsion comprising from about 5 wt % to about 30 wt % wax.

The multilayer water-dispersible article of any one of paragraphs [00184] to [00207], wherein the wax comprises a paraffin wax, a beeswax, or a combination thereof.

The multilayer water-dispersible article of any one of claims paragraphs [00184] to [00208], wherein the wax comprises a blend of two or more different waxes.

The multilayer water-dispersible article of paragraphs [00208] or [00209], wherein the wax comprises from about 10 wt % to about 90 wt % paraffin wax and from about 10 wt % to about 90 wt % beeswax, based on the total weight of the wax.

The multilayer water-dispersible article of any one of paragraphs [00184] to [00210], wherein the wax has a melting point in a range of about 40° C. to about 100° C.

The multilayer water-dispersible article of any one of paragraphs [00184] to [00211], wherein the article has a moisture vapor transmission rate (MVTR) in a range of about 60 g H₂O/m²/day to about 250 g H₂O/m²/day.

The multilayer water-dispersible article of any one of paragraphs [00184] to [00212], wherein the article has a moisture vapor transmission rate (MVTR) in a range of about 60 g H₂O/m²/day to about 205 g H₂O/m²/day.

The multilayer water-dispersible article of any one of paragraphs [00184] to [00213], wherein the article has a moisture vapor transmission rate (MVTR) in a range of about 60 g H₂O/m²/day to about 150 g H₂O/m²/day.

The multilayer water-dispersible article of any one of paragraphs [00184] to [00214], wherein the article has a moisture vapor transmission rate (MVTR) in a range of about 60 g H₂O/m²/day to about 100 g H₂O/m²/day.

The multilayer water-dispersible article of any one of paragraphs [00184] to [00215], wherein the water-soluble polymer comprises a mixture of an unmodified polyvinyl alcohol resin and carboxymethylcellulose, and the wax comprises a wax emulsion comprising beeswax, polysorbate 80, and water.

A method of making a multilayer water-dispersible article comprising:
admixing a water-soluble polymer and a wax emulsion to provide a primary composition; and,
casting or extruding the primary composition to provide the multilayer water-dispersible article, wherein the water-dispersible article has a moisture vapor transmission rate (MVTR) of about 60 g H₂O/m²/day to about 300 g H₂O/m²/day.

The method of paragraph [00217], wherein the water-soluble polymer is selected from one or more in the group of polyvinyl alcohol, polyacrylamide, poly(acrylic acid), poly(methacrylic acid), polyvinylpyrrolidone, quaternary ammonium polymers, and a cellulose ether.

The method of paragraph [00218], wherein the water-soluble polymer comprises an unmodified polyvinyl alcohol.

The method of paragraph [00218] or [00219], wherein the water-soluble polymer comprises an anionic group-modified polyvinyl alcohol resin modified with one or more in the group of itaconic acid, monomethyl maleate, aminopropyl sulfonate, maleic acid, maleic anhydride, n-vinylpyrrolidone, n-vinylcaprolactam, and a derivative of any of the foregoing.

The method of paragraph [00220], wherein the anionic group-modified polyvinyl alcohol comprises at least 0.5 mol % anionic group modification.

The method of paragraph [00220] or [00221], wherein the anionic group-modified polyvinyl alcohol comprises from about 1.0 to about 4.0 mol % anionic group modification.

The method of any one of paragraphs [00220] to [00222], wherein the anionic group-modified polyvinyl alcohol comprises from about 1.0 to about 3.5 mol % anionic group modification.

The method of any one of paragraphs [00218] to [00223], wherein the polyvinyl alcohol has a degree of hydrolysis of at least 88 mol %.

The method of any one of paragraphs [00218] to [00224], wherein the polyvinyl alcohol has a degree of hydrolysis in a range from 90 mol % to less than 99 mol %.

The method of any one of paragraphs [00218] to [00225], wherein the polyvinyl alcohol has a 4% aqueous viscosity at 20° C. of at least about 6 cP.

The method of any one of paragraphs [00218] to [00226], wherein the water-soluble polymer comprises a cellulose ether.

The method of paragraph [00227], wherein the cellulose ether comprises carboxymethylcellulose.

The method of any one of paragraphs [00217] to [00228], wherein the wax emulsion comprises a paraffin wax, a beeswax, or a combination thereof.

The method of paragraph [00229], wherein the wax emulsion comprises the paraffin wax, the beeswax, or the combination thereof in an amount in a range of about 5 wt % to about 30 wt %, based on the total weight of the wax emulsion.

The method of any one of paragraphs [00217] to [00230], further comprising admixing the water-soluble polymer and the wax emulsion with one or more additional components in the group of includes a plasticizer, a filler, a surfactant, an anti-block agent, an antioxidant, a slip agent, and a dispersant to provide the primary composition.

The method of paragraph [00231], wherein the plasticizer comprises glycerol, diglycerol, propylene glycol, dipropylene glycol, ethylene glycol, diethylene glycol, triethylene glycol, a polyethylene glycol up to MW 400, sorbitol, 2-methyl-1,3-propanediol, ethanolamines, trimethylolpropane (TMP), a polyether polyol, isomalt, maltitol, xylitol, erythritol, adonitol, dulcitol, pentaerythritol, mannitol, or a combination of any of the foregoing.

The method of paragraph [00231] or [00232], wherein the plasticizer comprises sorbitol, xylitol, or a combination thereof.

The method of any one of paragraphs [00231] to [00233], wherein the plasticizer is present in the primary composition in an amount in a range of about 10 PHR to about 25 PHR, based on 100 parts by weight of the water-soluble polymer.

The method of any one of paragraphs [00217] to [00234], wherein the wax emulsion is present in the primary composition in an amount in a range of about 70 PHR to about 200 PHR, based on the 100 parts by weight of the water-soluble polymer.

The method of paragraph [00235], wherein the wax emulsion is provided in the primary composition in an amount in a range of about 90 PHR to about 120 PHR, based on 100 parts by weight of the water-soluble polymer.

The multilayer water-dispersible articles in accordance with the disclosure can be better understood in light of the following examples, which are merely intended to illustrate the multilayer water-dispersible articles and are not meant to limit the scope thereof in any way.

### EXAMPLES

### Example 1: Formation and Characterization of a Multilayer Water-Dispersible Article from a Substrate Layer and a Coating Layer

Water-dispersible substrate layers comprising (A) PVOH/monomethyl maleate (MMM) copolymers, or (B) PVOH homopolymers were prepared through solution casting and drying. The PVOH homopolymer-based substrate layers further included glycerin, propylene glycol, sorbitol and xylitol as plasticizers in a total amount of about 50 PHR (˜30 wt % of the layer), a cellulose, and other various additives. The PVOH/MMM copolymer-based substrate layers further included glycerin, sorbitol, and diglycerol as plasticizers in a total amount of about 7.5 PHR (˜6.6 wt % of the layer), a starch, and other various additives. The substrate layers had thicknesses as shown in Tables 1 and 2.

The substrate layers were coated with various coating layers at the indicated thicknesses and weights, indicated in Tables 1 and 2. The compositions of the coating layers included a 100 wt % paraffin wax emulsion (AQUACER 494), a 100 wt % beeswax emulsion (BEE'S MILK), a 50 wt % paraffin wax and 50 wt % beeswax emulsion blend, and a 100 wt % monomethyl maleate polyvinyl alcohol having about a 1.7 mol % modification, a 4 wt % aqueous viscosity of about 26 cP and a DH of about 90%. AQUACER 494 is a paraffin wax emulsion containing about 50% paraffin wax and about 2% of stearate and ethoxylated sorbitan monostearate, with the remainder being water. BEE'S MILK is a beeswax emulsion (55 wt % solids) containing from about 10-15% beeswax, 10-15% sesame oil, and no more than 9% of hydrogenated lecithin, sorbitan stearate, capryloyl glycol, phenoxyethanol and hexylene glycol, with the remainder being water. The coating layers were melted and applied to the substrate layer using a Mayer rod, as indicated in Table 2. If no Mayer rod is indicated, the coating layer was prepared individually by solvent casting and drying and subsequently applied to the substrate layer by pressing the coating layer to the substrate layer, for example, by lamination.

All values in Tables 1-4 are presented as the average of 3 samples, with the exception of the permeation values. The permeation values are the result of single measurements.

TABLE 1
Substrate Layer Composition

| | | | | Substrate |
|---|---|---|---|---|
| | | | % wt | Layer |
| Substrate | | % wt | plasticizer | Thickness |
| Layer | Type | PVOH | (PHR) | (μm) |
| A | PVOH/MMM | 90 | 6.6 | 50.8 |
| | copolymer | | | |
| B | PVOH | 56 | 30 | 50.8 |
| | homopolymer | | | |

TABLE 2
Article Compositions

| | | | | Coating | Coating | Article |
|---|---|---|---|---|---|---|
| | Substrate | Coating | Mayer | Thickness | Weight | Thickness |
| Article | Layer | Composition | Rod | (μm) | (g/m²) | (μm) |
| 1 | A | Paraffin Wax | #5 Mayer | 14.7 | 15.1 | 65.5 |
| 2 | A | Beeswax | #5 Mayer | 19.6 | 22.2 | 70.4 |
| 3 | A | PVOH | N/A | 25.4 | 21.9 | 76.2 |
| 4 | A | 50:50 Paraffin | #5 Mayer | 25.9 | 13.2 | 76.7 |
| | | wax:Beeswax Blend | | | | |
| 5 | A | Paraffin Wax | #30 Mayer | 62.2 | 28.4 | 113.0 |
| 6 | A | Beeswax | #30 Mayer | 28.5 | 33.7 | 79.2 |
| 7 | A | PVOH | N/A | 50.8 | 59.7 | 101.6 |
| 8 | A | 50:50 Paraffin | #30 Mayer | 36.1 | 51.9 | 86.9 |
| | | wax:Beeswax Blend | | | | |
| 9 | B | Paraffin Wax | #5 Mayer | 12.2 | 17.4 | 63.0 |
| 10 | B | Beeswax | #5 Mayer | 30.0 | 10.7 | 70.8 |
| 11 | B | PVOH | N/A | 25.4 | 32.3 | 76.2 |
| 12 | B | 50:50 Paraffin | #5 Mayer | 35.1 | 8.9 | 85.9 |
| | | wax:Beeswax Blend | | | | |
| 13 | B | Paraffin Wax | #30 Mayer | 67.8 | 24.2 | 118.6 |
| 14 | B | Beeswax | #30 Mayer | 0.5 | 17.9 | 51.3 |
| 15 | B | PVOH | N/A | 50.8 | 47.9 | 101.6 |
| 16 | B | 50:50 Paraffin | #30 Mayer | 36.8 | 38.7 | 87.6 |
| | | wax:Beeswax Blend | | | | |

The articles were then tested for MVTR, percent residue, disintegration and dissolution at 23° C. (as provided by MSTM 205, above), peel strength and coefficient of friction (COF, as measured for the coating side of the article), using the methods described herein. The results of these tests are shown in Tables 3 and 4, below.

TABLE 3
Moisture Performance of Multilayer Water-Dispersible Articles

| | MVTR | Average | Average | Average % |
|---|---|---|---|---|
| Article | (g H₂O/m²/day) | Disintegration(s) | Dissolution(s) | Residue |
| A* | 71.2 | 10.0 | 19.7 | 0 |
| B* | 314.5 | 6.7 | 15.0 | 0 |
| 1 | 2.5 | 12.0 | 101.0 | 0 |
| 2 | 45.5 | 10.0 | 24.7 | 0 |
| 3 | 23.5 | 18.7 | 44.7 | 0 |
| 4 | 2.5 | 210 | 300.0 | 90 |
| 5 | 6.5 | 17.7 | 300.0 | 25 |
| 6 | 27.4 | 19.0 | 63.3 | 0 |
| 7 | 30.0 | 57.3 | 115.0 | 0 |
| 8 | 1.7 | 31.0 | 300.0 | 98 |
| 9 | 3.0 | 14.0 | 58.0 | 0 |
| 10 | 107.7 | 9.3 | 24.0 | 0 |
| 11 | 31.9 | 15.3 | 49.7 | 0 |
| 12 | 9.4 | 23.5 | 58.0 | 0 |
| 13 | 16.0 | 11.7 | 71.7 | 0 |
| 14 | 16.4 | 9.0 | 26.3 | 0 |
| 15 | 34.6 | 18.7 | 66.3 | 0 |
| 16 | 4.5 | 48.0 | 300.0 | 98 |

*Articles A and B represent the substrate layers of Table 1 having no coating layer thereon.

As shown in Table 3, articles 1, 9 and 12 each had MVTR values of less than 10 g H₂O/m²/day, disintegration times of less than about 30 s and dissolution times of less than about 120 s. Articles 5 and 8 similarly met these standards other than a dissolution time of no more than 120 s. Rather, articles 5 and 8 demonstrated an average of 25% and 98% residue, respectively, after 300 s of being submerged in water. Article 4, having exceptional MVTR, had a disintegration and dissolution times of 210 s and at least 300 s, respectively. Articles 14 and 15 demonstrated excellent disintegration and dissolution times, but had MVTRs slightly above 10 g H₂O/m²/day, at 16.4 and 34.6H₂O/m²/day, respectively. Advantageously, all tested articles having a coating layer showed a decrease in the MVTR as compared to the corresponding substrate layer having no coating thereon. Articles 6 and 13, although having an MVTR of about 27 and 16 g H₂O/m²/day, respectively, demonstrated exceptional disintegration and dissolution times.

Without intending to be bound by theory, coating layers applied with a #5 Mayer Rod (i.e. articles 1, 2, 9, 10 and 12, with the exception of article 4) result in thinner coating layers, generally causing the resultant multilayer water-dispersible article to be more susceptible to breaking than those applied with the #30 Mayer Rod (i.e. articles 5, 6, 8, 13, 14 and 16). Accordingly, on average, coating layers applied with the #5 Mayer Rod generally demonstrated improved water-dispersibility (i.e. average disintegration time of 13.8 s) and water-solubility (i.e. average dissolution time of 53.1 s) than those applied with the #30 Rod, having an average disintegration time of 22.7 s and average dissolution time of 176.7 s.

Additionally, as shown by these data, because substrate layer B is a homopolymer and comprises a greater amount of plasticizer, this substrate layer generally disintegrates more quickly in water.

TABLE 4
Physical Properties of Multilayer Water-Dispersible Articles

| | Low Seat | Average |
|---|---|---|
| | Temperature | Low Peel |
| Article | (° C.) | Strength (N) |
| A* | 198.9 | 5.7 |
| B* | 132.2 | 27.5 |
| 1 | 198.9 | 10.4 |
| 2 | 198.9 | 5.5 |
| 3 | 160.0 | 40.1 |
| 4 | 176.7 | 13.1 |
| 5 | 160.0 | 16.6 |
| 6 | 193.3 | 12.3 |
| 7 | 165.6 | 60.9 |
| 8 | 182.2 | 16.0 |
| 9 | 176.7 | 15.6 |
| 10 | 187.8 | 9.8 |
| 11 | 171.1 | 36.5 |
| 12 | 148.9 | 17.9 |
| 13 | 171.1 | 17.1 |
| 14 | 160.0 | 8.2 |
| 15 | 171.1 | 47.4 |
| 16 | 154.4 | 22.7 |

*Articles A and B represent the substrate layers of Table 1 having no coating layer thereon.

The data in Table 4 generally demonstrate that all tested articles, except Articles 2, 10, and 14, each having a coating layer of 100 wt % beeswax, had peel strengths in accordance with the disclosure. As further shown in Table 4, articles 11 and 15, with a coating layer thereon, had peel strengths higher than that of the uncoated substrate layer B (i.e. 27.5 N). Similarly, all but article 2, which had a comparable seal strength to the uncoated substrate layer, had peel strengths higher than the uncoated substrate layer A (i.e. 5.7 N).

### Example 2: Peel Strength Data of the Article of Example 1

The peel strength at differing seal temperatures was examined in detail. As shown in Tables 5 and 6 below, the peel strength (N) for various coating layers for each of the tested substrate layers was evaluated at different sealing temperatures. The data presented in Tables 5 and 6 are the averages of three measured values and indicates whether the seal resulted in peeling (P) or tearing (T).

TABLE 5
Peel Strength Data (N) for PVOH Homopolymer Substrate Layer Having Various Coatings

| | Temperature, ° F. (° C.) | | | | | | | | | | | | | | |
|---|---|---|---|---|---|---|---|---|---|---|---|---|---|---|---|
| | 240 | 250 | 260 | 270 | 280 | 290 | 300 | 310 | 320 | 330 | 340 | 350 | 360 | 370 | 380 |
| Coating | (116) | (121) | (127) | (132) | (138) | (143) | (149) | (154) | (160) | (166) | (171) | (177) | (182) | (188) | (193) |
| NONE | 9.6 | 17.7 | 25.4 | 27.6 | 22.6 | 27.5 | 24.6 | | | | | | | | |
| | (P) | (P) | (P) | (T) | (T) | (T) | (T*) | | | | | | | | |
| 50:50 | 1.5 | 4.0 | 6.0 | 11.7 | 13.3 | 16.5 | 17.9 | | | | | | | | |
| beeswax:paraffin | (P) | (P) | (P) | (P) | (T*) | (P) | (T) | | | | | | | | |
| wax (#5 Mayer Rod) | | | | | | | | | | | | | | | |
| 50:50 | 2.0 | 2.7 | 4.0 | 9.2 | 14.6 | 16.6 | 12.3 | 22.7 | 17.3 | | | | | | |
| beeswax:paraffin | (P) | (P) | (P) | (P) | (P) | (P) | (P) | (T) | (T) | | | | | | |
| wax (#30 Mayer rod) | | | | | | | | | | | | | | | |
| Paraffin wax (#5 | 0.2 | 0.1 | 1.3 | 1.0 | 1.9 | 5.3 | 3.7 | 5.7 | 9.0 | 6.7 | 8.7 | 15.6 | | | |
| Mayer rod) | (P) | (P) | (P) | (P) | (P) | (P) | (P) | (P) | (P) | (P) | (P) | (T) | | | |
| Paraffin wax (#30 | 0.4 | 0.2 | 0.8 | 1.8 | 1.7 | 2.0 | 2.6 | 4.8 | 6.8 | 5.6 | 15.8 | 18.1 | | | |
| Mayer rod) | (P) | (P) | (P) | (P) | (P) | (P) | (P) | (P) | (P) | (P) | (T) | (T) | | | |
| Beeswax (#5 Mayer | 0.2 | 0.4 | 0.4 | 0.5 | 0.9 | 0.6 | 2.7 | 3.6 | 3.5 | 0.6 | 1.6 | 3.4 | 8.3 | 9.8 | 12.7 |
| rod) | (P) | (P) | (P) | (P) | (P) | (P) | (P) | (P) | (P) | (P) | (P) | (P) | (P*) | (T) | (T) |
| Beeswax (#30 Mayer | 0.9 | 1.1 | 1.7 | 1.5 | 1.6 | 3.2 | 7.7 | 5.0 | 8.2 | 8.7 | | | | | |
| rod) | (P) | (P) | (P) | (P) | (P) | (P) | (P*) | (P) | (T) | (T) | | | | | |
| PVOH (25.4 μm thick) | 0.2 | 0.5 | 12.2 | 0.6 | 0.9 | 1.1 | 1.4 | 6.3 | 35.8 | 18.0 | 36.5 | 36.5 | | | |
| | (P) | (P) | (P) | (P) | (P) | (P) | (P) | (P) | (P) | (P) | (T) | (T) | | | |
| PVOH (50.8 μm thick) | 0.2 | 0.2 | 0.3 | 0.3 | 0.6 | 0.9 | 6.1 | 25.1 | 35.3 | 32.7 | 47.4 | 39.5 | | | |
| | (P) | (P) | (P) | (P) | (P) | (P) | (P) | (P) | (P) | (P) | (T) | (T) | | | |

*The articles were tested in triplicate;
P*indicates two of the three films resulted in peeling, while one resulted in tearing;
T*indicates two of the three films resulted in tearing, while one resulted in peeling.

TABLE 6
Peel Strength Data for PVOH/MMM Copolymer Substrate Layer

| | Temperature, ° F. (° C.) | | | | | | | | | | | | |
|---|---|---|---|---|---|---|---|---|---|---|---|---|---|
| | 280 | 290 | 300 | 310 | 320 | 330 | 340 | 350 | 360 | 370 | 380 | 390 | 400 |
| Coating | (138) | (143) | (149) | (154) | (160) | (166) | (171) | (177) | (182) | (188) | (193) | (199) | (204) |
| NONE | 1.9 | 6.0 | 12.6 | 9.9 | 4.1 | 7.2 | 13.1 | 9.3 | 10.0 | 9.2 | 11.1 | 5.7 | 11.5 |
| | (P) | (P) | (P) | (P) | (P) | (P) | (P*) | (T*) | (T*) | (P*) | (T*) | (T) | (T) |
| 50:50 | 3.7 | 2.9 | 4.6 | 7.0 | 8.5 | 6.5 | 7.3 | 13.1 | 16.0 | 9.6 | 5.3 | 7.9 | 5.6 |
| beeswax:paraffin | (P) | (P) | (P) | (P*) | (P) | (P*) | (P) | (T) | (T*) | (T*) | (T) | (T) | (T) |
| wax (#5 Mayer Rod) | | | | | | | | | | | | | |
| 50:50 | 2.7 | 5.1 | 3.7 | 4.2 | 7.6 | 8.3 | 9.6 | 11.2 | 16.0 | 18.9 | 14.9 | 18.3 | 18.5 |
| beeswax:paraffin | (P) | (P) | (P) | (P) | (P) | (P) | (P) | (P) | (T) | (T) | (T*) | (T*) | (T) |
| wax (#30 Mayer rod) | | | | | | | | | | | | | |
| Paraffin wax (#5 | 0.9 | 1.8 | 3.1 | 4.8 | 5.2 | 4.8 | 5.1 | 5.4 | 5.9 | 6.5 | 5.7 | 10.4 | 9.3 |
| Mayer rod) | (P) | (P) | (P) | (P) | (P) | (P) | (P) | (P) | (P) | (P*) | (T) | (T) | (T) |
| Paraffin wax (#30 | 10.5 | 4.6 | 3.8 | 3.9 | 16.6 | 9.4 | 5.1 | 19.8 | 13.7 | 9.1 | 11.7 | 10.5 | 4.5 |
| Mayer rod) | (P) | (P) | (P) | (P*) | (T) | (T*) | (T*) | (T) | (T) | (T) | (T) | (T) | (T) |
| Beeswax (#5 Mayer | 2.3 | 3.1 | 2.7 | 7.7 | 6.3 | 4.9 | 4.0 | 2.7 | 9.1 | 4.3 | 2.3 | 5.5 | 4.8 |
| rod) | (P) | (P) | (P) | (P) | (P) | (P) | (P) | (P) | (P*) | (P) | (P) | (T*) | (P) |
| Beeswax (#30 Mayer | 3.5 | 2.3 | 2.6 | 3.7 | 7.3 | 8.5 | 4.3 | 10.9 | 7.2 | 5.4 | 12.3 | 10.6 | 10.7 |
| rod) | (P) | (P) | (P) | (P) | (P*) | (P*) | (P) | (P) | (P*) | (P*) | (T) | (T) | (T) |
| PVOH (25.4 μm thick) | 0.6 | 1.4 | 8.1 | 36.4 | 40.1 | 42.7 | 38.1 | 22.7 | 38.5 | 31.9 | 30.6 | 17.0 | 24.0 |
| | (P) | (P) | (P) | (P) | (T) | (T*) | (T) | (T) | (T) | (T) | (T) | (T) | (T) |
| PVOH (50.8 μm thick) | 3.0 | 1.5 | 3.1 | 16.8 | 49.1 | 60.9 | 66.0 | 58.8 | 63.6 | 49.4 | 37.1 | 25.7 | 22.6 |
| | (P) | (P) | (P) | (P) | (T*) | (T) | (T) | (T) | (T) | (T) | (T) | (T) | (T) |

*The articles were tested in triplicate;
P*indicates two of the three films resulted in peeling, while one resulted in tearing;
T*indicates two of the three films resulted in tearing, while one resulted in peeling.

Tables 5 and 6 generally show that the heat sealing of the articles according to the disclosure improves as the temperature increases, within the temperature range tested. Articles coated with 100 wt % paraffin wax using a #30 Mayer Rod indicated superior heat sealing compared to the other tested coatings.

Surprisingly and advantageously, as demonstrated in Table 6, the coating layer tended to improve the sealability of the articles having a PVOH/MMM substrate layer, as compared to those having an uncoated PVOH/MMM substrate layer. That is, the peel strengths for the articles that resulted in film failure (i.e. tearing) tended to be higher for articles having a coated PVOH/MMM substrate layer than those having an uncoated PVOH/MMM substrate layer. For example, when coated with a 50:50 beeswax:paraffin wax blend, the article had seal strengths ranging up to about 16.0 N and 18.9 N when the coating was applied with a #5 and #30 Mayer Rod, respectively. Further, when coated with a paraffin wax coating, the seal strength ranged up to about 16.6 N. Articles having a PVOH coating layer with thicknesses of 25.4 μm or 50.8 μm, demonstrated seal strengths up to about 42.7 N and 66.0 N, respectively. In contrast, the uncoated substrate layer had a maximum seal strength resulting in tearing of only 11.5 N. Such an increase in the seal strengths for the coated PVOH/MMM substrate layer would not have been expected, particularly in view of the seal strengths for the coated PVOH-homopolymer substrate layer, which were generally comparable, if not lower than those for the uncoated PVOH-homopolymer substrate layer.

### Example 3: Evaluation of Film MVTR

The MVTR of various films comprising a wax were evaluated. Films were prepared in accordance with Table 7, below. BEE'S MILK beeswax emulsion (55 wt % solids), as described in Example 1, was used as the wax, and polysorbate 80 was used as the surfactant. The films were generally prepared by mixing together the components, followed by casting the resulting solution into a film. Specifically, the liquid components were combined, followed by the polyvinyl alcohol resin. The mixture was brought to a boil and held at 65° C. overnight (>8 hours), and a film was case from the emulsified mixture using a doctor blade or a slot die. The MVTR of each film was obtained using the methods described herein, and are reported in Table 7, below.

TABLE 7
Tested Film Compositions (all amounts in PHR)

| Film | 17 | 18 | 19 | 20 | 21 |
|---|---|---|---|---|---|
| PVOH | 100 | 100 | 100 | 100 | 100 |
| (88% DH, 8 cps) | | | | | |
| CMC | 17.04 | 17.04 | 17.04 | 17.04 | 17.04 |
| Surfactant | 1.43 | 1.43 | 1.43 | 1.43 | 1.43 |
| Glycerol | 0 | 0 | 0 | 8.52 | 8.52 |
| Sorbitol | 6.52 | 6.52 | 6.52 | 6.52 | 6.52 |
| Xylitol | 8.52 | 8.52 | 8.52 | 8.52 | 8.52 |
| Wax | 172.42 | 64.19 | 0 | 64.19 | 0 |
| MVTR | 22 | 19.4 | 18 | 60 | 205 |

As shown in Table 7, by adding the wax to the film composition (Film 20 vs Film 21), the MVTR was reduced from 205 g H₂O/m²/day (Film 21) to 60 g H₂O/m²/day (Film 20). It was further observed that reducing the amount of plasticizers had a beneficial impact on the MVTR (Film 20 vs Film 18), but resulted in less extensible films. Without intending to be bound by theory, it was believed that the reduction of MVTR upon reduction of plasticizer in the presence of wax would similarly occur irrespective of the identity and physical state of the plasticizer(s). For example, this trend is expected to continue even if the glycerol, sorbitol, and/or xylitol plasticizer package was modified to include other suitable plasticizers, as described herein, whether those were plasticizers were liquid or solid at room temperature. Further, it was observed that in the absence of glycerol, as the amount of wax decreased, the MVTR of the resulting film decreased (comparing Films 17-19). However, in the presence of glycerol, as the amount of wax increased, the MVTR of the resulting film decreased (comparing films 20 and 21). Without intending to be bound by theory, it is believed that the wax can contribute plasticizing properties to the film, which can in turn increase the MVTR of the film.

### Example 4: Evaluation of Dioxane Content of Films

All the films in Table 9, below, were tested for dioxane content (in ppm) by Galbraith Laboratories, using GLI Procedure GC-100H. As shown below, all films demonstrated advantageously low dioxane content (e.g., less than 5 ppm dioxane).

Film A included a blend of PVOH resins, in particular, a 60:40 ratio of a polyvinyl alcohol homopolymer and a 4 mol % monomethyl maleate modified PVOH, respectively. The film further included plasticizers and surfactants and process aids in about 28 wt %, including ethoxylated or polyol-type chemistries in about 3.5 wt %. Advantageously, Film A had less than 5 ppm dioxane.

Film B included a blend of PVOH resins, in particular, a 60:40 ratio of a polyvinyl alcohol homopolymer and a 4 mol % monomethyl maleate modified PVOH, respectively. The film further included plasticizers, surfactants and process aids in about 28 wt %, including ethoxylated or polyol-type chemistries in about 3.5 wt %. Advantageously, Film B had less than 4 ppm dioxane.

Film C included a blend of PVOH resins, in particular, a 70:30 ratio of a polyvinyl alcohol homopolymer and a 4 mol % monomethyl maleate modified PVOH, respectively. The film further included plasticizers, surfactants and process aids in about 28 wt %, including ethoxylated or polyol-type chemistries in about 3.3 wt %. Advantageously, Film C had less than 3 ppm dioxane.

Film D included a 5 mol % methyl acrylate modified PVOH resin in about 63 wt %. The film further included plasticizers, surfactants and process aids in about 35 wt %. Advantageously, Film D had less than 4 ppm dioxane.

Film E included a 5 mol % methyl acrylate modified PVOH resin in about 63 wt %. The film further included plasticizers, surfactants and process aids in about 35 wt %. Advantageously, Film E had less than 2 ppm dioxane.

Film F included 100 PHR of 1.7 mol % monomethyl maleate modified PVOH resin. The film further included plasticizers, surfactants and process aids in about 13.3 PHR. Advantageously, Film F had less than 3 ppm dioxane.

Film G included 100 PHR of 1.7 mol % monomethyl maleate modified PVOH resin. The film further included plasticizers, surfactants and process aids in about 13.3 PHR. Advantageously, Film G had less than 4 ppm dioxane.

Film H included 100 PHR of 1.7 mol % monomethyl maleate modified PVOH resin and 14.67 PHR of K-120 polyvinylpyrrolidone resin. The film further included plasticizers, surfactants and process aids in about 16 PHR. Advantageously. Film H had less than 5 ppm dioxane.

Film I included a methyl acrylate modified PVOH resin in about 63 wt % The film further included plasticizers, surfactants, and process aids in about 23.6 wt %. Advantageously, Film I had less than 5 ppm dioxane.

Film J included a PVOH resin, a 4 mol % methyl methacrylate modified PVOH resin in about 76.5 wt %. The film further included plasticizers, surfactants and process aids in about 35 wt %. Advantageously, Film J had less than 5 ppm dioxane.

Film K included 100 PHR of 1.7 mol % monomethyl maleate modified PVOH resin. The film further included plasticizers, surfactants, and process aids in about 29.4 PHR. Advantageously, Film K had less than 3 ppm dioxane.

TABLE 9
Dioxane Content of PVOH Films

| | | Dioxane |
|---|---|---|
| | Film Weight | Level |
| Film | Tested (mg) | (ppm)¹ |
| A | 276.84 | <5 |
| B | 371.68 | <4 |
| C | 474.52 | <3 |
| D | 397.99 | <4 |
| E | 656.06 | <2 |
| F | 522.22 | <3 |
| G | 381.38 | <4 |
| H | 308.20 | <5 |
| I | 287.90 | <5 |
| J | 310.93 | <5 |
| K | 426.19 | <3 |

¹The number listed is the detection limit, and the true value was less than the listed detection limit.

The foregoing description is given for clearness of understanding only, and no unnecessary limitations should be understood therefrom, as modifications within the scope of the invention may be apparent to those having ordinary skill in the art.

All patents, publications and references cited herein are hereby fully incorporated by reference. In case of conflict between the present disclosure and incorporated patents, publications and references, the present disclosure should control.

1. A multilayer water-dispersible article, optionally a film, comprising a polymer layer comprising a water-soluble polymer and a wax layer comprising a wax, wherein the wax is present in an amount ranging from about 5 PHR to about 200 PHR, based on 100 parts by weight of the water-soluble polymer, and the multilayer water-dispersible article has a moisture vapor transmission rate (MVTR) of about 60 g H₂O/m²/day to about 300 g H₂O/m²/day.

2. The multilayer water-dispersible article of claim 1, wherein the wax is selected from the group consisting of paraffin wax, microcrystalline wax, natural petroleum wax, synthetic petroleum wax, carnauba wax, candelilla wax, beeswax, and any mixture of any of the foregoing.

3. The multilayer water-dispersible article of claim 1, wherein the polymer layer or wax layer further comprises one or more of oxidized polyethylene, mineral oil, wood rosin, shellac, a triglyceride, linseed oil, corn oil, canola oil, hemp oil, coconut oil, unmodified polyvinyl alcohol, anionic group modified polyvinyl alcohol, polyacrylamide, poly(acrylic acid), poly(methacrylic acid), polyvinylpyrrolidone, quaternary ammonium polymers, polyvinyl acetate, ethylene vinyl alcohol, alginate, a polysaccharide, a protein, a pH-adjusted protein, wood pulp, non-wood pulp, non-woven fiber, natural foam, synthetic foam, and a derivative of any of the foregoing.

4. The multilayer water-dispersible article of claim 1, wherein the water-soluble polymer comprises polyvinyl alcohol, polyacrylamide, poly(acrylic acid), poly(methacrylic acid), polyvinylpyrrolidone, quaternary ammonium polymers, a cellulose ether, or any mixture of any of the foregoing.

5. The multilayer water-dispersible article of claim 4, wherein the water-soluble polymer comprises an unmodified polyvinyl alcohol.

6. The multilayer water-dispersible article of claim 4, wherein the water-soluble polymer comprises an anionic group-modified polyvinyl alcohol resin modified with one or more in the group of itaconic acid, monomethyl maleate, aminopropyl sulfonate, maleic acid, maleic anhydride, n-vinylpyrrolidone, n-vinylcaprolactam, and a derivative of any of the foregoing.

7. The multilayer water-dispersible article of claim 6, wherein the anionic group-modified polyvinyl alcohol comprises a polyvinyl alcohol modified with monomethyl maleate.

8. The multilayer water-dispersible article of claim 6, wherein the anionic group-modified polyvinyl alcohol comprises at least 0.5 mol % anionic group modification.

9. The multilayer water-dispersible article of claim 6, wherein the anionic group-modified polyvinyl alcohol comprises from about 1.0 to about 4.0 mol % anionic group modification.

10. The multilayer water-dispersible article of claim 6, wherein the anionic group-modified polyvinyl alcohol comprises from about 1.0 to about 3.5 mol % anionic group modification.

11. The multilayer water-dispersible article of claim 4, wherein the polyvinyl alcohol has a degree of hydrolysis of at least 88 mol %.

12. The multilayer water-dispersible article of claim 4, wherein the polyvinyl alcohol has a degree of hydrolysis in a range from 90 mol % to less than 99 mol %.

13. The multilayer water-dispersible article of claim 4, wherein the polyvinyl alcohol has a 4% aqueous viscosity at 20° C. of at least about 6 cP.

14. The multilayer water-dispersible article of claim 4, wherein the water-soluble polymer comprises a cellulose ether.

15. The multilayer water-dispersible article of claim 14, wherein the cellulose ether comprises carboxymethylcellulose.

16. The multilayer water-dispersible article of claim 1, wherein the multilayer water-dispersible article comprises a first face and a second face opposing the first face, wherein the first face comprises the polymer layer and the second face comprises the wax layer.

17. The multilayer water-dispersible article of claim 1, wherein the multilayer water-dispersible article is in a form of a pouch defining an interior pouch volume, the pouch having an interior surface facing the interior pouch volume and an exterior surface opposing the interior surface, and the wax layer forms at least a portion of the exterior surface of the pouch.

18. The multilayer water-dispersible article of claim 1, wherein the multilayer water-dispersible article is in a form of a pouch defining an interior pouch volume, the pouch having an interior surface facing the interior pouch volume and an exterior surface opposing the interior surface, and the wax layer forms at least a portion of the interior surface of the pouch.

19. The multilayer water-dispersible article of claim 1, further comprising an intermediate region disposed between the polymer layer and the wax layer, the intermediate region comprising a mixture of the water-soluble polymer and the wax.

20. The multilayer water-dispersible article of claim 1, wherein the polymer layer or the wax layer further comprises a plasticizer.

21. The multilayer water-dispersible article of claim 20, wherein the plasticizer comprises glycerol, diglycerol, propylene glycol, dipropylene glycol, ethylene glycol, diethylene glycol, triethylene glycol, a polyethylene glycol up to MW 400, sorbitol, 2-methyl-1,3-propanediol, ethanolamines, trimethylolpropane (TMP), a polyether polyol, isomalt, maltitol, xylitol, erythritol, adonitol, dulcitol, pentaerythritol, mannitol, or a combination of any of the foregoing.

22. The multilayer water-dispersible article of claim 1, wherein the polymer layer or the wax layer further comprises a filler, a surfactant, an anti-block agent, an antioxidant, a slip agent, a dispersant, or a combination of any of the foregoing.

23. The multilayer water-dispersible article of claim 22, wherein the plasticizer, the filler, the surfactant, the anti-block agent, the antioxidant, the slip agent, the dispersant, or the combination of any of the foregoing is admixed with the water-soluble polymer.

24. The multilayer water-dispersible article of claim 1, wherein the wax comprises a wax emulsion comprising from about 5 wt % to about 30 wt % wax.

25. The multilayer water-dispersible article of claim 1, wherein the wax comprises a paraffin wax, a beeswax, or a combination thereof.

26. The multilayer water-dispersible article of claim 1, wherein the wax comprises a blend of two or more different waxes.

27. The multilayer water-dispersible article of claim 25, wherein the wax comprises from about 10 wt % to about 90 wt % paraffin wax and from about 10 wt % to about 90 wt % beeswax, based on a total weight of the wax.

28. The multilayer water-dispersible article of claim 1, wherein the wax has a melting point in a range of about 40° C. to about 100° C.

29.-53. (canceled)
